(19) United States
(12) Patent Application Publication
(10) Pub. No.: US 2024/0187943 A1
(43) Pub. Date: Jun. 6, 2024

(54) SERVICE CONTINUITY ON PREFERRED CELL DURING CONNECTED MODE MOBILITY

(71) Applicant: QUALCOMM INCORPORATED, San Diego, CA (US)

(72) Inventors: Muralidharan Murugan, Hyderabad (IN); Nitin Pant, San Diego, CA (US); Shashidhar Vummintala, Bangalore (IN); Xuepan Guan, San Diego, CA (US); Sham Sunder Kantayapalem, Hyderabad (IN)

(21) Appl. No.: 18/553,648

(22) PCT Filed: Apr. 22, 2022
(86) PCT No.: PCT/US2022/025943

§ 371 Date: Oct. 2, 2023

(30) Foreign Application Priority Data
May 4, 2021 (IN) 202141020315

(51) Int. Cl. H04W 36/00; H04W 36/32

(52) U.S. Cl. CPC H04W 36/008355; H04W 36/0058; H04W 36/324

(57) ABSTRACT

Methods, systems, and devices for wireless communication are described. A user equipment. UE (115-a), may perform a cell measurement for at least some of a set of cells while operating in a connected mode. The UE may determine a subset of cells of the set of cells based on one or more of the cell measurement, cell-specific information (210), or UE-preferred cell information (215). The cell-specific information may include one or more respective cell parameters associated with at least some if not each cell of the subset of cells. The UE-preferred cell information may include one or more respective preferred cell parameters. The UE may transmit a cell measurement report (205) including an indication of one or more cells of the subset of cells based on the one or more cells of the subset of cells satisfying one or more cell measurement report criteria.

### CROSS REFERENCE

The present Application is a 371 national stage filing of International PCT Application No. PCT/US2022/025943 by MURUGAN et al. entitled “SERVICE CONTINUITY ON PREFERRED CELL DURING CONNECTED MODE MOBILITY,” filed Apr. 22, 2022; and claims priority to India Provisional Patent Application No. 202141020315 by MURUGAN et al. entitled “SERVICE CONTINUITY ON PREFERRED CELL DURING CONNECTED MODE MOBILITY,” filed May 4, 2021, each of which is assigned to the assignee hereof, and each of which is expressly incorporated by reference in its entirety herein.

### TECHNICAL FIELD

The following relates to wireless communication, including managing continuity of wireless communication services on a cell during a connected mode mobility.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems, which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless communications system may include one or more base stations, each simultaneously supporting wireless communication services for multiple communication devices, which may be otherwise known as user equipments (UEs). A base station may provide coverage via a cell. In some cases, the UE may move out of the cell and into another cell associated with another base station. The UE may perform a procedure in which the UE switches cells and camps on the other cell associated with the other base station. Before camping on a different cell, the UE may transmit a cell measurement report in response to performing cell measurements for various cells, and the measurement report may indicate cells that meet a measurement reporting criterion and on which the UE may camp. Although the cell measurement report indicates cells on which the UE may camp on, in some cases, these cells may be non-preferred cells by the UE. It may be desirable to provide improvements to handover, or redirection, or any other measurement-based mobility of the UE to a preferred cell instead of the non-preferred cells.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication at a user equipment (UE). The method may include performing a cell measurement for each of a set of cells while operating in a connected mode: determining a subset of cells of the set of cells based at least in part on one or more of the cell measurement, cell-specific information, or UE-preferred cell information, the cell-specific information comprising one or more respective cell parameters associated with each cell of the subset of cells, the UE-preferred cell information comprising one or more respective preferred cell parameters: and transmitting a cell measurement report including an indication of one or more cells of the subset of cells based at least in part on each of the one or more cells of the subset of cells satisfying one or more cell measurement report criteria.

Another innovative aspect of the subject matter described in this disclosure can be implemented in an apparatus for wireless communication at a UE. The apparatus may include a processor, memory coupled with the processor, and instructions stored in the memory. The instructions may be executable by the processor to cause the apparatus to perform a cell measurement for each of a set of cells while operating in a connected mode: determine a subset of cells of the set of cells based at least in part on one or more of the cell measurement, cell-specific information, or UE-preferred cell information, the cell-specific information comprising one or more respective cell parameters associated with each cell of the subset of cells, the UE-preferred cell information comprising one or more respective preferred cell parameters: and transmit a cell measurement report including an indication of one or more cells of the subset of cells based at least in part on each of the one or more cells of the subset of cells satisfying one or more cell measurement report criteria.

Another innovative aspect of the subject matter described in this disclosure can be implemented in another apparatus for wireless communication at a UE. The apparatus may include means for performing a cell measurement for each of a set of cells while operating in a connected mode: means for determining a subset of cells of the set of cells based at least in part on one or more of the cell measurement, cell-specific information, or UE-preferred cell information, the cell-specific information comprising one or more respective cell parameters associated with each cell of the subset of cells, the UE-preferred cell information comprising one or more respective preferred cell parameters: and means for transmitting a cell measurement report including an indication of one or more cells of the subset of cells based at least in part on the one or more cells of the subset of cells satisfying one or more cell measurement report criteria.

Another innovative aspect of the subject matter described in this disclosure can be implemented in a non-transitory computer-readable medium storing code for wireless communication at a UE. The code may include instructions executable by a processor to perform a cell measurement for each of a set of cells while operating in a connected mode: determine a subset of cells of the set of cells based at least in part on one or more of the cell measurement, cell-specific information, or UE-preferred cell information, the cell-specific information comprising one or more respective cell parameters associated with each cell of the subset of cells, the UE-preferred cell information comprising one or more respective preferred cell parameters: and transmit a cell measurement report including an indication of one or more cells of the subset of cells based at least in part on the one or more cells of the subset of cells satisfying one or more cell measurement report criteria.

Some examples of the method, apparatuses, and non-transitory computer-readable medium described herein may further include operations, features, means, or instructions for ordering, in the cell measurement report, the one or more cells of the subset of cells based at least in part on a respective priority associated with each cell of the one or more cells, the indication identifying the ordering of the one or more cells of the subset of cells in the cell measurement report.

Some examples of the method, apparatuses, and non-transitory computer-readable medium described herein may further include operations, features, means, or instructions for determining a respective priority for each of the one or more respective preferred cell parameters associated with the UE-preferred cell information. In some examples of the method, apparatuses, and non-transitory computer-readable medium described herein, determining of the subset of cells of the set of cells may be based at least in part on the determining of the respective priority for each of the one or more respective preferred cell parameters associated with the UE-preferred cell information.

Some examples of the method, apparatuses, and non-transitory computer-readable medium described herein may further include operations, features, means, or instructions for determining a preferred cell type from a plurality of cell types based at least in part on the UE-preferred cell information. In some examples of the method, apparatuses, and non-transitory computer-readable medium described herein, determining of the subset of cells of the set of cells may be based at least in part on the preferred cell type and a respective cell type associated with each of the one or more cells of the subset of cells.

### BRIEF DESCRIPTION OF THE DRAWINGS

FIGS. 1 and 2 illustrate examples of wireless communications systems that support a service continuity on a preferred cell during a connected mode mobility in accordance with aspects of the present disclosure.

FIGS. 3 and 4 show flowcharts illustrating methods that support a service continuity on a preferred cell during a connected mode mobility in accordance with aspects of the present disclosure.

FIGS. 5 and 6 show block diagrams of devices that support a service continuity on a preferred cell during a connected mode mobility in accordance with aspects of the present disclosure.

FIG. 7 shows a block diagram of a communications manager that supports a service continuity on a preferred cell during a connected mode mobility in accordance with aspects of the present disclosure.

FIG. 8 shows a diagram of a system including a device that supports a service continuity on a preferred cell during a connected mode mobility in accordance with aspects of the present disclosure.

FIGS. 9-12 show flowcharts illustrating methods that support a service continuity on a preferred cell during a connected mode mobility in accordance with aspects of the present disclosure.

### DETAILED DESCRIPTION

A wireless communications system may include various communication devices, such as a user equipment (UE) and one or more base stations, which may provide wireless communication services to the UE. Each base station may provide a coverage for the wireless communication services via a cell, which may be a geographic coverage area in which each base station provides coverage for the UE. The UE may support a mobility procedure to enable the UE to move (for example, roam) within the wireless communications system without interruptions in the wireless communication services. The UE may also operate in various modes, for example, an idle mode or a connected mode. If operating in the connected mode, the one or more base stations may manage the mobility procedure for the UE based on cell measurement reports received from the UE, among other information.

A UE may camp on a cell in the wireless communications system and, while the UE is camping on the cell, the UE may perform cell measurements on one or more neighboring cells. For example, the UE may perform cell measurements on the one or more neighboring cells to determine a neighboring cell on which the UE can camp. The cell measurements may support multiple radio access technologies (RATs) including fourth generation (4G) systems, such as 4G Long-Term Evolution (LTE), as well as fifth generation (5G) systems, which may be referred to as 5G new radio (NR), among other examples. The cell measurements may also support intra-RAT cell measurements or inter-RAT cell measurements. Based on the cell measurements, the UE may generate and transmit a cell measurement report to one or more of the cells the UE is camped on or a respective neighboring cell. A respective base station associated with the cell may trigger a mobility procedure for the UE based on the received cell measurement report. For example, the received cell measurement report may trigger the respective base station to handover or redirect the UE to a neighboring cell.

Although the cell measurement report may indicate neighboring cells that the UE may camp on, in some cases, these cells may be not preferred by the UE (referred to herein as “non-preferred cells”). By performing handover, or redirection, or other measurement-based mobility of the UE to a non-preferred cell, the UE may experience reduced performance or quality of service (QOS) associated with wireless communication services. A preferred cell may be a cell that supports one or more UE-preferred cell parameters (also referred to as UE-preferred cell features), while a non-preferred cell may be a cell in which one or more UE-preferred cell parameters are unsupported. For example, a UE may be deployed in a high-speed train (HST) network. As such, a UE-preferred cell feature may be a cell supporting HST-related wireless communication services and a non-preferred cell may be a cell not supporting HST-related wireless communication services. Based on some other, different cell measurement reporting techniques, the UE may include non-HST cells (for example, non-preferred cells in which HST-related wireless communication services are unsupported) in a cell measurement report, which may possibly trigger the UE to be handed over or redirected to a non-HST cell.

As a result, a cell the UE is camped on may handover or redirect the UE to a non-HST cell leading to reduced UE performance in the HST network. As such, if a UE includes a non-preferred cell in a cell measurement report that triggers UE mobility, the network may handover or redirect the UE to a non-preferred cell causing the UE to experience reduced performance or QoS for the UE-preferred cell feature, among other disadvantages. Some other examples of UE-preferred cell features include inter-RAT cells or intra-RAT cells. If a UE includes a non-preferred inter-RAT cell in a cell measurement report that triggers UE mobility, the cell the UE is camped on may handover or redirect the UE to a non-preferred inter-RAT cell. Other examples of UE-preferred cell features may include LTE-NR dual connectivity (DC), a closed subscriber group (CSG), enhanced multimedia broadcast multicast service (eMBMS), or cellular vehicle-to-everything (CV2X), among other examples.

Various aspects generally relate to cell measurement reporting, and more specifically, to handover or redirection, or any other connected mode mobility of a UE to a preferred cell based on the cell measurement reporting. In some examples, a UE may bias a cell measurement report to increase a probability for the UE to camp on a preferred cell over a non-preferred cell. The UE may bias the cell measurement report by prioritizing preferred cells over non-preferred cells in the cell measurement report. For example, the UE may order the preferred cells and the non-preferred cells in the cell measurement report based on a priority of each of one or more UE-preferred cell parameters. In some examples, the UE may assign a higher rank to a preferred cell that supports a UE-preferred cell parameter compared to a non-preferred cell for which the UE-preferred cell parameter is unsupported.

In some examples, the UE may assign a higher rank to a preferred cell that supports a first UE-preferred cell parameter having a higher priority than another preferred cell that supports a second UE-preferred cell parameter having a lower priority than the first UE-preferred cell parameter. In some examples, the UE may omit one or more preferred cells or non-preferred cells from inclusion in the cell measurement report. By biasing the cell measurement report to prioritize preferred cells, the cell measurement report may trigger the network to handover or redirect the UE to a preferred cell, which may maintain or improve the UE performance by ensuring service continuity for the UE.

Particular aspects of the subject matter described in this disclosure may be implemented to realize one or more of the following potential advantages. The techniques employed by the described UEs may provide benefits and enhancements to the operation of the UEs, including reduced power consumption, and may promote higher reliability and lower latency wireless communication services by triggering the network to handover or redirect the UEs to preferred cells. For example, a UE may increase battery life by efficiently camping on preferred cells that support UE-preferred cell features. A UE may camp on an HST supported cell over non-HST supported cells. By camping on the HST supported cell, the UE may experience uninterrupted communication services, which may preserve a battery life of the UE because the UE may avert having to use additional resources (for example, processing resources) for HST related applications. Additionally, a UE may promote higher reliability and lower latency wireless communication services by camping on preferred cells that support UE-preferred cell features as opposed to non-preferred cells that do not support UE-preferred cell features. As described in the above example, by camping on the HST supported cell, the UE may experience uninterrupted communication services.

Aspects of the disclosure are initially described in the context of wireless communications systems. Aspects of the disclosure are further illustrated by and described with reference to apparatus diagrams, system diagrams, and flowcharts that relate to service continuity on preferred cell during connected mode mobility.

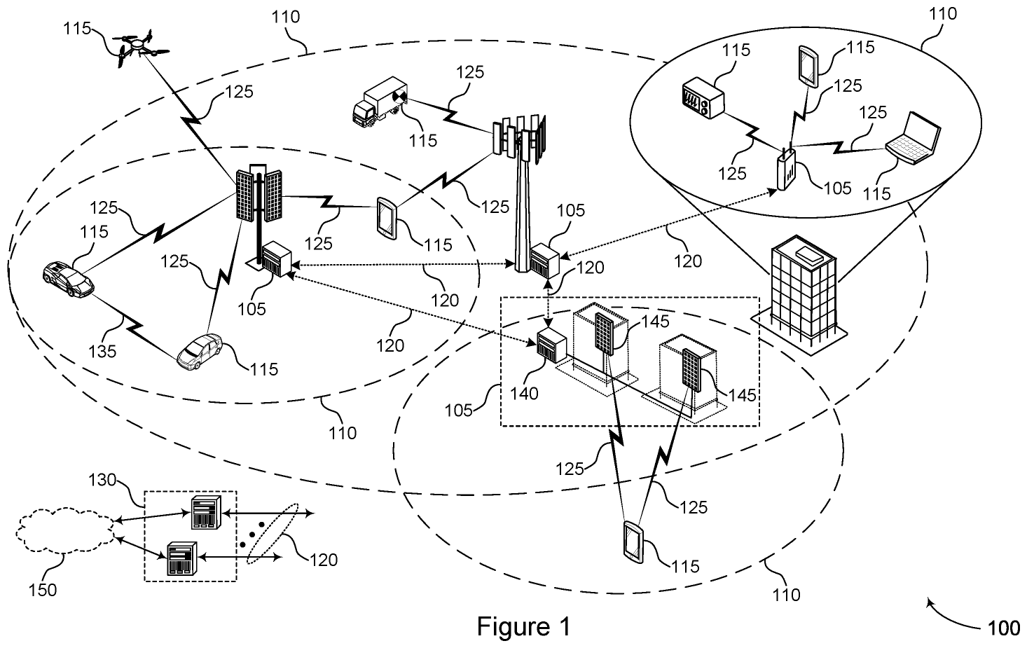

FIG. 1 illustrates an example of a wireless communications system 100 that supports a service continuity on a preferred cell during a connected mode mobility in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (for example, mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 that the UEs 115 and the base station 105 may establish one or more communication links 125. The coverage area 110 may be an example of a geographic area that a base station 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (for example, core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (for example, via an S1, N2, N3, or other interface). The base stations 105 may communicate with one another over the backhaul links 120 (for example, via an X2, Xn, or other interface) either directly (for example, directly between base stations 105), or indirectly (for example, via core network 130), or both. In some examples, the backhaul links 120 may be or include one or more wireless links. One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a bandwidth part (BWP)) that is operated according to one or more physical layer channels for a given radio access technology (RAT) (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (for example, in a carrier aggregation configuration), a carrier may also have acquisition signaling or control signaling that coordinates operations for other carriers. A carrier may be associated with a frequency channel (for example, an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (for example, of the same or a different RAT).

The communication links 125 shown in the wireless communications system 100 may include uplink transmissions from a UE 115 to a base station 105, or downlink transmissions from a base station 105 to a UE 115. Carriers may carry downlink or uplink communications (for example, in an FDD mode) or may be configured to carry downlink and uplink communications (for example, in a TDD mode). A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular RAT (for example, 1.4, 3, 5, 10, 15, 20, 40, or 80 megahertz (MHz)). Devices of the wireless communications system 100 (for example, the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (for example, a sub-band, a BWP) or all of a carrier bandwidth.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol duration (for example, a duration of one modulation symbol) and one subcarrier, where the symbol duration and subcarrier spacing are inversely related. The number of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs. The time intervals for the base stations 105 or the UEs 115 may be expressed in multiples of a basic time unit that may, for example, refer to a sampling duration of Tₛ=1/(Δfₘₐₓ·N_{f}) seconds, where Δfₘₐₓ may represent the supported subcarrier spacing, and N_{f} may represent the supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some examples, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol durations (for example, depending on the length of the cyclic prefix prepended to each symbol duration). The wireless communications system 100, a slot may further be divided into multiple mini-slots containing one or more symbols. Excluding the cyclic prefix, each symbol duration may contain one or more (for example, N_{f}) sampling durations. The duration of a symbol duration may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, the number of symbol durations in a TTI) may be variable. Additionally or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol durations and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (for example, over a carrier) and may be associated with an identifier for distinguishing neighboring cells (for example, a physical cell identifier (PCID), a virtual cell identifier (VCID), or others). In some examples, a cell may also refer to a geographic coverage area 110 or a portion of a geographic coverage area 110 (for example, a sector) over which the logical communication entity operates. Such cells may range from smaller areas (for example, a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (for example, several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A base station 105 may support one or multiple cells and may also support communications over the one or more cells using one or multiple component carriers. In some examples, a carrier may support multiple cells, and different cells may be configured according to different protocol types (for example, MTC, narrowband IoT (NB-IOT), enhanced mobile broadband (eMBB)) that may provide access for different types of devices.

Various aspects generally relate to a communication device, such as a UE 115 to enable biasing a cell measurement report to increase a likelihood for the UE 115 to camp on a preferred cell over a non-preferred cell in a wireless communications system. A preferred cell may be a cell that supports one or more UE-preferred cell parameters (also referred to as UE-preferred cell features), while a non-preferred cell may be a cell for which one or more UE-preferred cell parameters are unsupported. The UE may bias the cell measurement report by prioritizing preferred cells over non-preferred cells in the cell measurement report. For example, the UE 115 may order the preferred cells and the non-preferred cells in the cell measurement report based on a priority of each UE-preferred cell parameter.

In some examples, the UE 115 may assign a higher rank to a preferred cell that supports a UE-preferred cell parameter compared to a non-preferred cell for which the UE-preferred cell parameter is unsupported. In some other examples, the UE 115 may assign a higher rank to a preferred cell that supports a UE-preferred cell parameter having a higher priority compared to another preferred cell that supports another UE-preferred cell parameter having a lower priority. In other examples, the UE 115 may omit one or more preferred cells or non-preferred cells from the cell measurement report. By biasing the cell measurement report to prioritize preferred cells, the cell measurement report may trigger the network to handover or redirect the UE 115 to a preferred cell, which may maintain or improve the UE performance by ensuring service continuity for the UE 115, among other benefits.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (for example, via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (for example, a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode if not engaging in active communications, operating over a limited bandwidth (for example, according to narrow band communications), or a combination of these techniques. For example, some UEs 115 may be configured for operation using a narrow band protocol type that is associated with a defined portion or range (for example, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The D2D communication link 135 may be an example of a communication channel, such as a sidelink communication channel, between vehicles (for example, UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (for example, base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (for example, radio heads and ANCs) or consolidated into a single network device (for example, a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHZ, also known as the centimeter band, or in an extremely high frequency (EHF) region of the spectrum (for example, from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) RAT, or NR technology in an unlicensed band such as the 5 GHz industrial, scientific, and medical (ISM) band. If operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (for example, LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (for example, a base station 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (for example, by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (for example, a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (for example, by a base station 105 or a UE 115) may be performed using multiple beam directions, and the device may use a combination of digital precoding or radio frequency beamforming to generate a combined beam for transmission (for example, from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (for example, for identifying a beam direction for subsequent transmission or reception by the UE 115) or for transmitting a signal in a single direction (for example, for transmitting data to a receiving device).

A receiving device (for example, a UE 115) may try multiple receive configurations (for example, directional listening) if receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array that may be referred to as “listening” according to different receive configurations or receive directions. In some examples, a receiving device may use a single receive configuration to receive along a single beam direction (for example, if receiving a data signal). The single receive configuration may be aligned in a beam direction determined based on listening according to different receive configuration directions (for example, a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (for example, using a cyclic redundancy check (CRC)), forward error correction (FEC), and retransmission (for example, automatic repeat request (ARQ)). HARQ may improve throughput at the MAC layer in poor radio conditions (for example, low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A base station 105 may be movable and provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network having different types of the base stations 105 provide coverage for various geographic coverage areas 110 using the same or different RATs.

In the wireless communications system 100, each base station 105 may provide a coverage for wireless communication services via a cell, which may be a coverage area 110 that each base station 105 provides coverage for one or more UE 115. A UE 115 may support a mobility procedure to enable the UE 115 to roam within the wireless communications system 100 without disruptions in the wireless communication services. For example, a UE 115 may camp on a cell associated with a base station 105 in the wireless communications system 100 and, while the UE 115 is camping on the cell, the UE 115 may perform cell measurements on one or more neighboring cells (for example, one or more neighboring base stations 105). Based on the cell measurements, the UE 115 may generate and transmit a cell measurement report to the cell associated with the base station 105 that the UE 115 is camped on. The base station 105 may trigger the mobility procedure for the UE 115 based on the received cell measurement report. For example, the received cell measurement report may trigger the base station 105 to handover or redirect the UE 115 to a neighboring cell (for example, a neighboring base station 105).

In some cases, even though a cell measurement report indicates neighboring cells that a UE 115 may possibly camp on, these cells may be non-preferred cells by the UE 115. A non-preferred cell may be a cell for which one or more UE-preferred cell parameters are not supported. By handing over or redirecting a UE 115 to a non-preferred cell, the UE 115 may experience reduced performance associated with wireless communication services in the wireless communications system 100. Various aspects of the present disclosure relate to handover or redirection, or any other connected mode mobility of a UE 115 to a preferred cell (for example, a preferred base station 105) in the wireless communications system 100. A preferred cell may be a cell that supports one or more UE-preferred cell parameters. To increase a likelihood for the UE 115 to camp on a preferred cell over a non-preferred cell in the wireless communications system 100, the UE 115 may bias a cell measurement report.

A UE 115 may bias a cell measurement report by ordering preferred cells over non-preferred cells in the cell measurement report. For example, a UE 115 may order preferred cells and non-preferred cells in a cell measurement report based on a priority of each UE-preferred cell parameter. In some examples, a UE 115 may assign a higher priority to a preferred cell that supports a UE-preferred cell parameter compared to a non-preferred cell for which the UE-preferred cell parameter is unsupported. In some other examples, a UE 115 may assign a higher order to a preferred cell that supports a UE-preferred cell parameter having a higher priority compared to another preferred cell that supports another UE-preferred cell parameter having a lower priority. In other examples, a UE 115 may omit one or more preferred cells or non-preferred cells from a cell measurement report based at least in part on one or more of the preferred cells or non-preferred cells not meeting a cell measurement reporting criterion.

By way of example, a first base station 105 associated with a first cell may support HST, a second base station 105 associated with a second cell may not support HST and may support high bandwidth, and a third base station 105 associated with a third cell may not support HST and may not support high bandwidth. Assuming all the above three cells satisfy a measurement reporting criterion, a UE 115 may prioritize the cells in a cell measurement report with the following order the first cell, the second cell, and the third cell. The UE 115 can prioritize preferred cells in the cell measurement report so that connected mode mobility or network triggered redirection happens to a preferred cell. That is, by biasing a cell measurement report to prioritize preferred cells, the cell measurement report may trigger a handover or a redirection of the UE 115 to a preferred cell (for example, a preferred base station 105), which may maintain or improve the UE 115 performance by ensuring service continuity for the UE 115, among other benefits. Various aspects of the present disclosure are applicable for inter-RAT measurement reporting as well biasing the reporting to include preferred cells for inter-RAT handover or inter-RAT redirection.

The wireless communications system 100 may maintain or improve wireless communication services. By configuring a UE 115 to bias a cell measurement report to improve a likelihood for the UE to camp on a preferred cell (for example, a preferred base station 105) over a non-preferred cell (for example, a non-preferred base station 105), the UE 115 may be handed over or redirected to the preferred cell (for example, a preferred base station 105), which may maintain or increase the reliability of the communication services for the UE 115 in the wireless communications system 100.

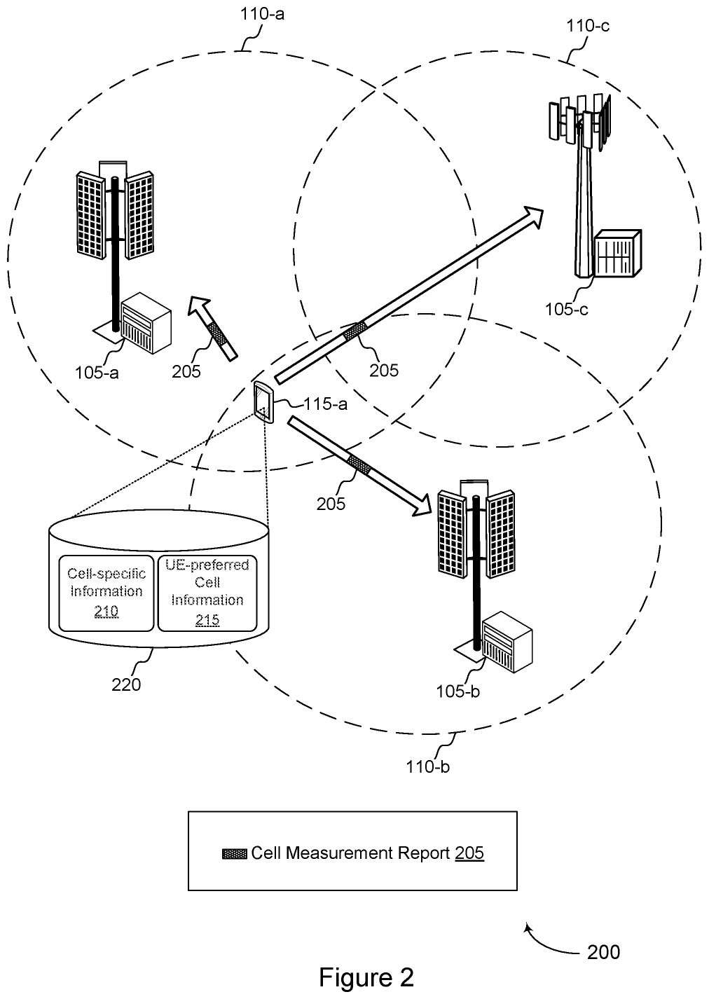

FIG. 2 illustrates an example of a wireless communications system 200 that supports a service continuity on a preferred cell during a connected mode mobility in accordance with aspects of the present disclosure. In some examples, the wireless communications system 200 may implement aspects of the wireless communications system 100 or may be implemented by aspects of the wireless communications system 100. For example, the wireless communications system 200 may include a UE 115-a, a base station 105-a within a geographic coverage area 110-a (also referred to as a cell 110-a), a base station 105-b within a geographic coverage area 110-b (also referred to as a cell 110-b), and a base station 105-c within a geographic coverage area 110-c (also referred to as a cell 110-c). The base station 105 and the UEs 115 may be examples of corresponding devices described herein with reference to FIG. 1. The wireless communications system 200 may support improvements to power consumption and may promote enhanced efficiency for higher reliability wireless communications, among other benefits.

In the example of FIG. 2, the UE 115-a may support a mobility procedure to enable the UE 115-a to roam within the wireless communications system 200 without interruptions in wireless communication services. The UE 115-a may also operate in various modes, for example, an idle mode (such as an RRC idle mode) or a connected mode (such as, an RRC connected mode). If operating in the connected mode, a respective base station 105 may facilitate the mobility procedure for the UE 115-a based on cell measurement reports received from the UE 115-a. The UE 115-a may camp on a cell 110, in the wireless communications system 200 and, while the UE 115-a is camping on the cell 110, the UE 115-a may perform cell measurements on one or more neighboring cells. For example, the UE 115-a may camp on the cell 110-a and may perform cell measurements on the one or more neighboring cells including one or more of the cell 110-b or the cell 110-c, to determine a neighboring cell for the UE 115-b to camp on.

The cell measurements may support multiple RATs including second generation (2G) RAT, third generation (3G) RAT, 4G RAT, such as 4G LTE, as well as 5G RAT, which may be referred to as 5G NR, among other examples. The UE 115-a may also support intra-RAT cell measurements or inter-RAT cell measurements. Based on the cell measurements, the UE 115-a may generate and transmit a cell measurement report 205 to the cell 110-a the UE 115-a is camped on, or one or more of the neighboring cell 110-b or the neighboring cell 110-c. The base station 105-a associated with the cell 110-a may trigger a mobility procedure for the UE 115-a based on the received cell measurement report 205. For example, the received cell measurement report 205 may trigger the base station 105-a to handover or redirect the UE 115-a to a neighboring cell, for example, the base station 105-b or the base station 105-c.

In some cases, a cell measurement report 205 indicating neighboring cells that the UE 115-a may camp on includes non-preferred cells by the UE 115-a. By handing over or redirecting the UE 115-a to a non-preferred cell, the UE 115-a may experience reduced performance or a QoS associated with wireless communication services. A preferred cell may be a cell that supports one or more UE-preferred cell parameters (also referred to as UE-preferred cell features), while a non-preferred cell may be a cell for which one or more UE-preferred cell parameters are unsupported. In the example of FIG. 2, one or more of the base station 105-a and the base station 105-b may be a preferred cell because each of these base stations 105 support UE-preferred cell parameters, while the base station 105-c may be a non-preferred cell because the base station 105-c does not support the UE-preferred cell parameters.

Various aspects of the present disclosure relate to handover, or redirection, or other mobility of the UE 115-a to a preferred cell (for example, a preferred base station 105) in the wireless communications system 200. To increase a possibility for the UE 115-a to camp on a preferred cell over a non-preferred cell in the wireless communications system 100, the UE 115-a may bias a respective cell measurement report 205. The UE 115-a may bias a respective cell measurement report 205 based at least in part on one or more of cell-specific information 210 or UE-preferred cell information 215, which may include any functionality, specification-defined cell feature or UE-preferred feature for the UE 115-a. For example, one or more of the cell-specific information 210 or the UE-preferred cell information 215 may include HST, evolved universal terrestrial radio access network (E-UTRAN) new radio (ENDC), EMR, throughput, power, CSG, eMBMS, CV2X, enhanced coverage, among other examples.

The UE 115-a may maintain, in the memory 220 associated with the UE 115-a for example, the cell-specific information 210, which may include cell-specific parameters (also referred to as cell-specific features). In some examples, the cell-specific information 210 may be a list of cell-specific parameters (also referred to a preferred cell list). Similarly, the UE 115-a may maintain, in the memory 220 associated with the UE 115-a, the UE-preferred cell information 215, which may include UE-preferred cell parameters. In some examples, the cell-specific information 210 may be a list of UE-preferred cell parameters (also referred to a feature priority list). The memory 220 may be a local memory or a remote memory (for example, a remote database). In some examples, the UE-preferred cell information 215 may be standalone or integrated with a database. In some examples, the memory 220 may be an acquisition database. In some other examples, the memory 220 may be a relational database (for example, a relational database management system (RDBMS) or a structured query language (SQL) database), a non-relational database, an object-oriented database, or other type of database, that stores one or more of the cell-specific information 210 or the UE-preferred cell information 215. In some examples, one or more of the cell-specific information 210 or the UE-preferred cell information 215 may be based at least in part on UE capability or a configuration (for example, a network configuration).

The UE 115-a may receive the cell-specific information 210 from one or more of the base station 105-a, the base station 105-b, or the base station 105-c. For example, one or more of the base station 105-a, the base station 105-b, or the base station 105-c may transmit, to the UE 115-a, system information that may include the cell-specific information 210. For example, one or more of the base station 105-a, the base station 105-b, or the base station 105-c may transmit, to the UE 115-a, one or more system information blocks (SIBs), which may include the cell-specific information 210. In some examples, a base station 105 that supports non-standalone (NSA) may include an information element (IE) in a SIB2, which may indicate the cell-specific information 210, for example an indication that the base station 105 supports NSA. In some other examples, a base station 105 that supports eMBMS may schedule a SIB13 in SIB1, which may indicate the cell-specific information 210, for example an indication that the base station 105 supports eMBMS.

Each base station 105 may have separate cell-specific parameters supported by each base station 105. In some examples, one or more of the base station 105-a, the base station 105-b, or the base station 105-c may have common cell-specific parameters supported by the one or more of the base station 105-a, the base station 105-b, or the base station 105-c. The cell-specific information 210 may include one or more of a cell global identifier (CGI), a network radio frequency spectrum band identifier (for example, an absolute radio-frequency channel number (EARFCN)), or a primary cell identifier (PCI). The UE 115-a determine one or more of the CGI, the EARFCN, or the PCI, based at least in part on the cell-specific information 210. Additionally or alternatively, the cell-specific information 210 may include a cell-specific feature mask (also referred to as a bitmask), which may indicate supported cell-specific parameters of a respective base station 105 (for example, a respective cell 110).

The UE 115-a may generate (for example, compile) the cell-specific information 210 over a duration by collecting the cell-specific information 210 based at least in part on cell measurements for one or more of the base station 105-a, the base station 105-b, or the base station 105-c. In some examples, the UE 115-a may generate (for example, compile) the cell-specific information 210 based at least in part on previously camping on one or more of the base station 105-a, the base station 105-b, or the base station 105-c. The UE 115-a may update the cell-specific information 210 based at least in part on an original equipment manufacturer (OEM) associated with the UE 115-a. In some examples, the UE 115-a may update the cell-specific information 210 based at least in part on a network operator (such as, a network carrier associated with one or more of the base station 105-a, the base station 105-b, or the base station 105-c). For example, the UE 115-a may receive control signaling indicating the UE-preferred cell information 215 or a request to update the cell-specific information 210. The update of the cell-specific information 210 may occur over a secure interface between the UE 115-a and one or more of the base station 105-a, the base station 105-b, or the base station 105-c using one or more encryption and decryption methods.

The UE-preferred cell information 215 may include one or more UE-preferred cell parameters. In some examples, the UE-preferred cell information 215 may be a list of UE-preferred cell parameters (for example, UE-preferred features). In some examples, the UE-preferred cell information 215 may indicate a preferred cell type by the UE 115-a. For example, the UE-preferred cell information 215 may indicate that a preferred cell type for the UE 115-a is an HST cell (in other words, a base station 105 that supports HST). The UE 115-a may order one or more UE-preferred cell parameters associated with the UE-preferred cell information 215. In some examples, the UE 115-a may order one or more UE-preferred cell parameters associated with the UE-preferred cell information 215 based at least in part on a priority of each of the one or more UE-preferred cell parameters.

The UE 115-a may order one or more UE-preferred cell parameters in an order of priority, such as a decreasing order of priority or an increasing order of priority. For example, the UE-preferred cell information 215 may include a first UE-preferred cell parameter indicating a preference for an HST cell, a second UE-preferred cell parameter indicating a preference for an ENDC cell, and a third UE-preferred cell parameter indicating a preference for a CSG cell. For a decreasing order, in the above example, the UE-preferred cell parameters may indicate a higher priority for the HST cell over the ENDC cell and the CSG cell. For an increasing order, in the above example, the UE-preferred cell parameters may indicate a lower priority for the HST cell over the ENDC cell and the CSG cell.

The UE-preferred cell information 215 including one or more UE-preferred cell parameters may be adaptive such that the UE-preferred cell information 215 may be dynamically updated by the UE 115-a. In some examples, the UE 115-a may update the UE-preferred cell information 215 including one or more UE-preferred cell parameters based at least in part on a battery power level (for example, an instantaneous battery power level) associated with the UE 115-a. In some other examples, the UE 115-a may update the UE-preferred cell information 215 including one or more UE-preferred cell parameters based at least in part on a mobility state associated with the UE 115-a. The UE 115-a may determine the mobility state based at least in part on sensor information (for example, instantaneous sensor information) from one or more sensors associated with the UE 115-a.

The UE 115-a may update the UE-preferred cell information 215 including one or more UE-preferred cell parameters based at least in part on a data throughput (for example, an instantaneous data throughput) associated with the UE 115-a. For example, the UE 115-a may update the UE-preferred cell information 215 including one or more UE-preferred cell parameters based at least in part on a downlink data throughput from a respective base station 105 to the UE 115-a, or an uplink data throughput from the UE 115-a to a respective base station 105. Additionally or alternatively, the UE 115-a may update the UE-preferred cell information 215 including one or more UE-preferred cell parameters based at least in part on determining that the UE 115-a is detected to be in an enhanced coverage mode based on measurements or sensor information indicating that the UE 115-a is in a cell edge or a low signal channel condition (for example, the UE 115-a may be inside an elevator or underground parking lot).

The UE-preferred cell information 215 including one or more UE-preferred cell parameters may be based on an OEM associated with the UE 115-a. In some examples, the UE 115-a may update the UE-preferred cell information 215 based at least in part on the OEM associated with the UE 115-a. The UE-preferred cell information 215 including one or more UE-preferred cell parameters may be based a network operator (for example, a network carrier associated with one or more of the base station 105-a, the base station 105-b, or the base station 105-c). In some examples, the UE 115-a may update the UE-preferred cell information 215 based at least in part on the network operator, for example, receiving control signaling indicating the UE-preferred cell information 215 or a request to update the UE-preferred cell information 215. The update of the UE-preferred cell information 215 may occur over-the-air (OTA) interface between the UE 115-a and one or more of the base station 105-a, the base station 105-b, or the base station 105-c using one or more encryption and decryption methods.

One or more of the cell-specific information 210 or the UE-preferred cell information 215 may be associated with a RAT. For example, one or more of the cell-specific information 210 or the UE-preferred cell information 215 may be associated with 4G RAT or 5G RAT, or other example RATs supported by the UE 115-a. Alternatively, one or more of the cell-specific information 210 or the UE-preferred cell information 215 may be shared across different RATs supported by the UE 115-a. For example, one or more of the cell-specific information 210 or the UE-preferred cell information 215 may be shared across 4G RAT and 5G RAT, or other example RATs. One or more of the cell-specific information 210 or the UE-preferred cell information 215 may be subscription-based.

In the example of FIG. 2, the UE 115-a may perform a cell measurement for each of a set of cells while operating in a connected mode and camping on a cell, which may be a preferred cell. For example, the UE 115-a may perform a cell measurement for each of the cell 110-b associated with the base station 105-b and the cell 110-c associated with the base station 105-c, while operating in a connected mode and camping on the cell 110-a associated with the base station 105-a. The UE 115-a may select the cell 110-b associated with the base station 105-b based at least in part on performing the cell measurement and comparing the cell-specific information 210 to the UE-preferred cell information 215 associated with the cell 110-b. For example, the UE 115-a may be deployed in an HST network. As such, a UE-preferred cell feature may be a cell that supports HST-related wireless communication services. For example, one or more of the base station 105-a and the base station 105-b may be a preferred cell because each of these base stations 105 support HST-related wireless communication services, while the base station 105-c may be a non-preferred cell because the base station 105-c does not support HST-related wireless communication services.

The UE 115-a may determine that the cell 110-b associated with the base station 105-b satisfies a cell measurement report criterion, and transmit a cell measurement report 205 including an indication of the cell 110-b associated with the base station 105-b. In some examples, the cell measurement report 205 may also include the cell 110-c associated with the base station 105-c, for example, based on a payload size of the cell measurement report 205. The cell 110-c associated with the base station 105-c may, however, be given a lower priority compared to the cell 110-b associated with the base station 105-b in the cell measurement report 205. Alternatively, the cell measurement report 205 may include one or more other cells that support UE-preferred cell parameters. The UE 115-a may prioritize including any cells that supports UE-preferred cell parameters (for example, HST-related wireless communication services) in the cell measurement report 205 over cells that do not support UE-preferred cell parameters (for example, HST-related wireless communication services). In other words, the UE 115-a may populate a cell measurement report 205 first with cells that support UE-preferred cell parameters and satisfy the cell measurement report criterion, and secondly with cells that do not support the UE-preferred cell parameters and satisfy the cell measurement report criterion.

The UE 115-a may be enabled to bias a cell measurement report 205 to include preferred cells determined based on the cell-specific information 210 and the UE-preferred cell information 215, as long as a preferred cell (for example, a cell 110 associated with a base station 105) meets the measurement reporting criteria. In other words, the UE 115-a is enabled to include cells supporting UE-preferred cell parameters in a cell measurement report 205, so that the network would trigger a connected mode mobility procedure, such as a handover or a redirection only to a preferred cell ensuring service continuity for the UE-preferred cell parameters. For example, the cell 110-a associated with the base station 105-a that the UE 115-a is camped on may handover or redirect the UE 115-a to the cell 110-b associated with the base station 105-b based at least in part on the cell measurement report 205. Likewise, the biasing of a cell measurement report 205 applies to other UE-preferred cell parameters, such as ENDC, CSG, or CV2X, or a combination thereof.

In some examples, one or more of the cell-specific information 210 or the UE-preferred cell information 215 may include inter-RAT cells or intra-RAT cells. Various aspects of the present disclosure may be extended to inter-RAT or intra-RAT cell measurement reporting, such that preferred cells are included as part of a cell measurement report 205. The UE 115-a may include inter-RAT or intra-RAT cell measurement reporting based at least in part on sharing one or more of the cell-specific information 210 or the UE-preferred cell information 215 across all supported RATs for the UE 115-a (for example, LTE, NR-5G, wideband code division multiple access (WCDMA), global system for mobile communications (GSM)).

In some examples, the UE 115-a may perform cell measurements LTE to NR connected mode cell measurements. If a UE-preferred cell parameter (for example, HST) is part of the UE-preferred cell information 215, an LTE RAT can refer to the NR RAT's cell-specific information 210 to prioritize preferred NR cells that support the UE-preferred cell parameter (for example, HST) to include those cells in a cell measurement report 205 sent to a base station 105 (for example, an LTE eNB). In some other examples, the UE 115-a may perform NR to LTE connected mode cell measurements. An NR RAT may refer to an LTE RAT's cell-specific information 210 to prioritize preferred LTE cells that support the UE-preferred cell parameter (for example, HST) to include those cells in a cell measurement report 205 sent to a base station 105 so that handover or redirection could be triggered to a preferred LTE cell.

The wireless communications system 200 may maintain or improve wireless communication services. By configuring a UE 115-a to bias a cell measurement report to improve a likelihood for the UE to camp on a preferred cell (for example, a preferred base station 105) over a non-preferred cell (for example, a non-preferred base station 105), the UE 115-a may be handed over or redirected to the preferred cell (for example, a preferred base station 105), which may increase the reliability of the communication services for the UE 115-a in the wireless communications system 200.

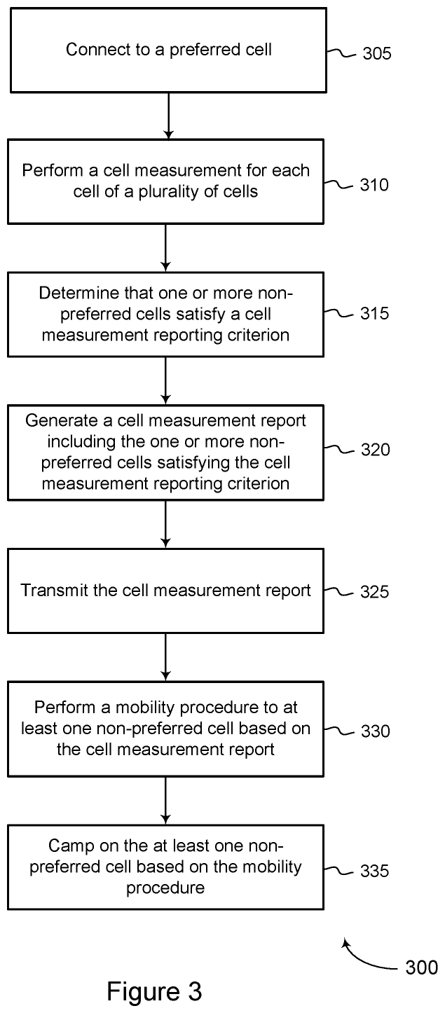

FIG. 3 illustrates an example of a method 300 that supports a service continuity on a preferred cell during a connected mode mobility in accordance with aspects of the present disclosure. The method 300 may implement aspects of the wireless communications system 100 and the wireless communications system 200, or may be implemented by aspects of the wireless communications system 100 and the wireless communications system 200. For example, the method 300 may be based on a configuration by a base station 105, which may be implemented by a UE 115. The base station 105 and the UE 115 may be examples of a base station 105 and a UE 115, as described with reference to FIGS. 1 and 2.

At 305, the UE 115 may connect to a preferred cell in a wireless communications system. The UE 115 may be configured to support cell measurements, as well as cell measurement reporting for one or more cell measurement reporting criterion (such as, A3, A4, A5, B1, and B2 connected mode measurement reporting). The following includes examples of cell measurement reporting criteria. In some examples, the UE 115 may trigger cell measurement reporting based at least in part on a metric of a serving cell associated with the UE 115 being greater than a threshold. In some other examples, the UE 115 may trigger cell measurement reporting based at least in part on a metric of a serving cell associated with the UE 115 being less than a threshold. In other examples, the UE 115 may trigger cell measurement reporting based at least in part on a metric of a neighboring cell being greater than a metric of a serving cell associated with the UE 115 by an offset (for example, a threshold). In some examples, the UE 115 may trigger cell measurement reporting based at least in part on a metric of a neighboring cell associated with the UE 115 being greater than a threshold. In some other examples, the UE 115 may trigger cell measurement reporting based at least in part on a metric of a neighboring cell associated with the UE 115 being less than a threshold.

At 310, the UE 115 may perform cell measurement for each cell of a plurality of cells, which may include preferred cells and non-preferred cells. At 315, the UE 115 may determine that one or more non-preferred cells satisfy a cell measurement reporting criterion.

At 320, the UE 115 may generate a cell measurement report including the one or more non-preferred cells satisfying the cell measurement reporting criterion. In some examples, the UE 115 may include one or more non-preferred cells as part of the cell measurement report by blindly including one or more non-preferred cells that have the best cell metric (for example, reference signal received power (RSRP), reference signal received quality (RSRQ)) and satisfy the cell measurement reporting criterion.

At 325, the UE 115 may transmit the cell measurement report. At 330, the UE 115 may perform mobility procedure to at least one non-preferred cell based on the cell measurement report. At 335, the UE 115 may camp on the at least one non-preferred cell based on the mobility procedure.

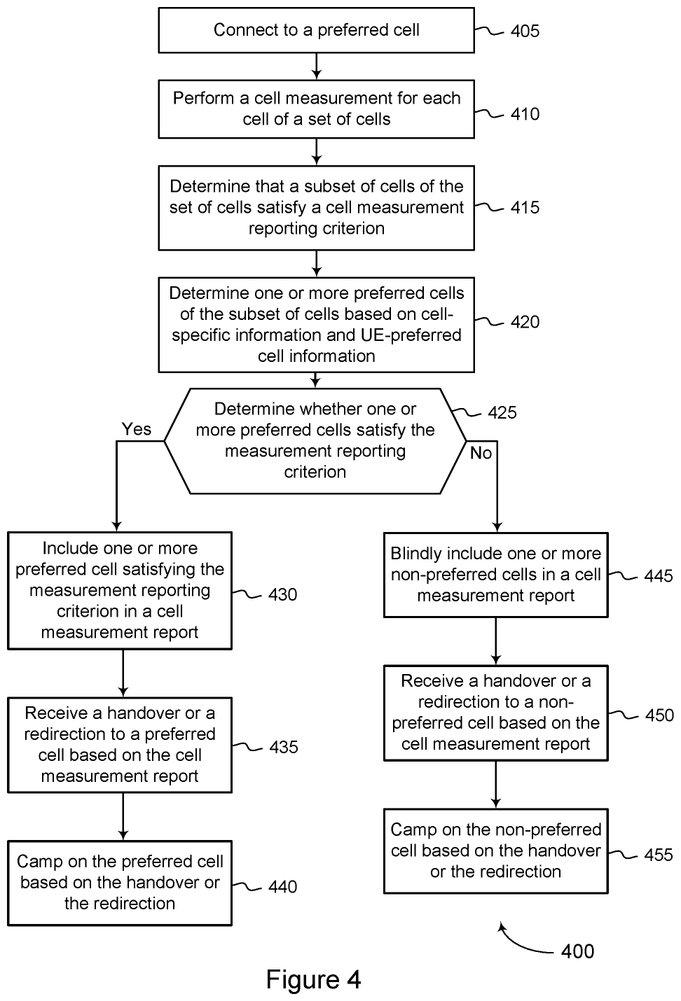

FIG. 4 illustrates an example of a method 400 that supports a service continuity on a preferred cell during a connected mode mobility in accordance with aspects of the present disclosure. The method 400 may implement aspects of the wireless communications system 100 and the wireless communications system 200, or may be implemented by aspects of the wireless communications system 100 and the wireless communications system 200. For example, the method 400 may be based on a configuration by a base station 105, which may be implemented by a UE 115. The base station 105 and the UE 115 may be examples of a base station 105 and a UE 115, as described with reference to FIGS. 1 and 2.

At 405, the UE 115 may connect to a preferred cell (for example, an HST cell, or another type of preferred cell). The UE 115 may be configured to support cell measurements, as well as cell measurement reporting for one or more cell measurement reporting criterion (for example, A3, A4, A5, B1, and B2 connected mode measurement reporting, among other examples).

At 410, the UE 115 may perform a cell measurement for each cell of a set of cells. In some examples, the UE 115 may perform a cell measurement for each cell of a set of cells while operating in a connected mode and camped on a cell, which may be the preferred cell. For example, the UE 115 may perform a cell measurement for one or more preferred cells and non-preferred cells while operating in a connected mode. Based on the cell measurements, at 415, the UE 115 may determine that a subset of cells of the set of cells satisfy the cell measurement reporting criterion.

At 420, the UE 115 may determine one or more preferred cells of the subset of cells based on cell-specific information (for example, a preferred cell list (PCL)) and UE-preferred cell information (for example, a feature priority list (FPL)). For example, the UE 115 may filter cells that satisfy the cell measurement reporting criterion and identify preferred cells based on one or more of the PCL or the FPL. The UE 115 may maintain a list of UE-preferred cell parameters. The UE 115 may maintain a list of UE-preferred cell parameters in an increasing order or a decreasing order of priority based at least in part on a UE state, an OEM configuration, a network carrier configuration, a user preference associated with the UE 115, or any combination thereof. Additionally or alternatively, the UE 115 may maintain a list of cell-specific cell parameters, which may indicate whether a respective cell supports an HST feature, an ENDC feature, a CSG feature, or an eMBMS feature. The UE 115 may determine the cell-specific information based on received SIBs from each respective cell while the UE 115 previously camped on each respective cell.

At 425, the UE 115 may determine whether one or more preferred cells satisfy the measurement reporting criterion. If the UE 115 determines that one or more preferred cells satisfy the measurement reporting criterion, at 430, the UE 115 may include the one or more preferred cell satisfying the measurement reporting criterion in a cell measurement report.

At 435, the UE 115 may receive a handover or a redirection to a preferred cell based on the cell measurement report. At 440, the UE 115 may camp on the preferred cell based on the handover or the redirection. As such, the UE 115 moves to the preferred cell and experiences better performance. Otherwise, if the UE 115 determines that there no preferred cells that satisfy the measurement reporting criterion, at 445, the UE 115 may blindly include one or more non-preferred cells in a cell measurement report. The one or more non-preferred cells satisfy the measurement reporting criterion.

At 450, the UE 115 may receive a handover or a redirection to a non-preferred cell based on the cell measurement report. At 455, the UE 115 may camp on the non-preferred cell based on the handover or the redirection. As such, the UE 115 moves to the non-preferred cell and experiences reduced performance.

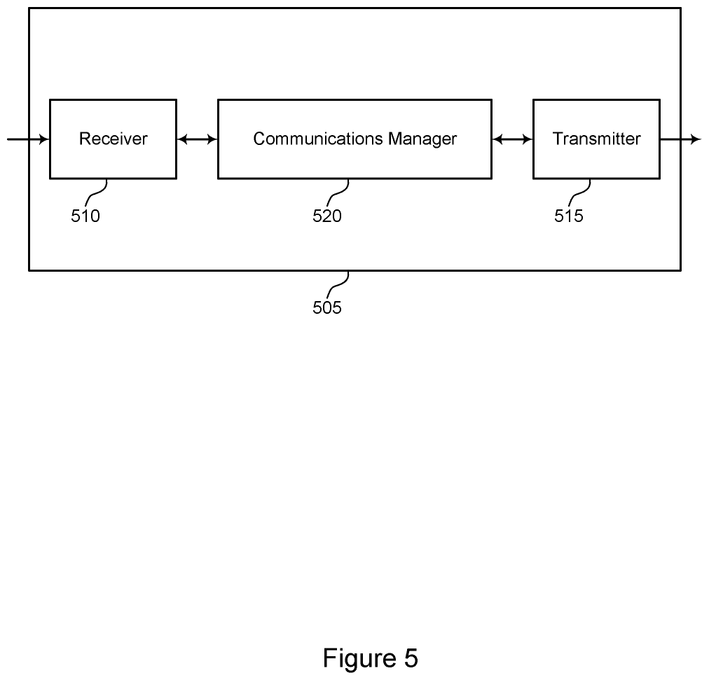

FIG. 5 shows a block diagram of a device 505 that supports a service continuity on a preferred cell during a connected mode mobility in accordance with aspects of the present disclosure. The device 505 may be an example of aspects of a UE 115. The device 505 may include a receiver 510, a transmitter 515, and a communications manager 520. The communications manager 520 can be implemented, at least in part, by one or both of a modem and a processor. Each of these components may be in communication with one another (for example, via one or more buses).

The receiver 510 may provide a means for receiving information such as packets, user data, control information, or any combination thereof associated with various information channels (for example, control channels, data channels, information channels related to service continuity on preferred cell during connected mode mobility). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (for example, control channels, data channels, information channels related to service continuity on preferred cell during connected mode mobility). In some examples, the transmitter 515 may be co-located with a receiver 510 in a transceiver component. The transmitter 515 may utilize a single antenna or a set of multiple antennas.

The communications manager 520, the receiver 510, the transmitter 515, or various combinations thereof or various components thereof may be examples of means for performing various aspects of service continuity on preferred cell during connected mode mobility. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (for example, in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally or alternatively, in some examples, the communications manager 520, the receiver 510, the transmitter 515, or various combinations or components thereof may be implemented in code (for example, as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (for example, configured as or otherwise supporting a means for performing the functions described in the present disclosure).

In some examples, the communications manager 520 may be configured to perform various operations (for example, receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations.

The communications manager 520 may support wireless communication at the device 505 (e.g., a UE) in accordance with examples as disclosed herein. For example, the communications manager 520 may be configured as or otherwise support a means for performing a cell measurement for each of a set of cells while operating in a connected mode. The communications manager 520 may be configured as or otherwise support a means for determining a subset of cells of the set of cells based at least in part on one or more of the cell measurement, cell-specific information, or UE-preferred cell information. The cell-specific information including one or more respective cell parameters associated with each cell of the subset of cells. The UE-preferred cell information including one or more respective preferred cell parameters. The communications manager 520 may be configured as or otherwise support a means for transmitting a cell measurement report including an indication of one or more cells of the subset of cells based at least in part on the one or more cells of the subset of cells satisfying one or more cell measurement report criteria.

By including or configuring the communications manager 520 to support service continuity on a preferred cell during a connected mode mobility, the device 505 (for example, a processor controlling or otherwise coupled to the receiver 510, the transmitter 515, the communications manager 520, or a combination thereof) may support techniques for reduced power consumption.

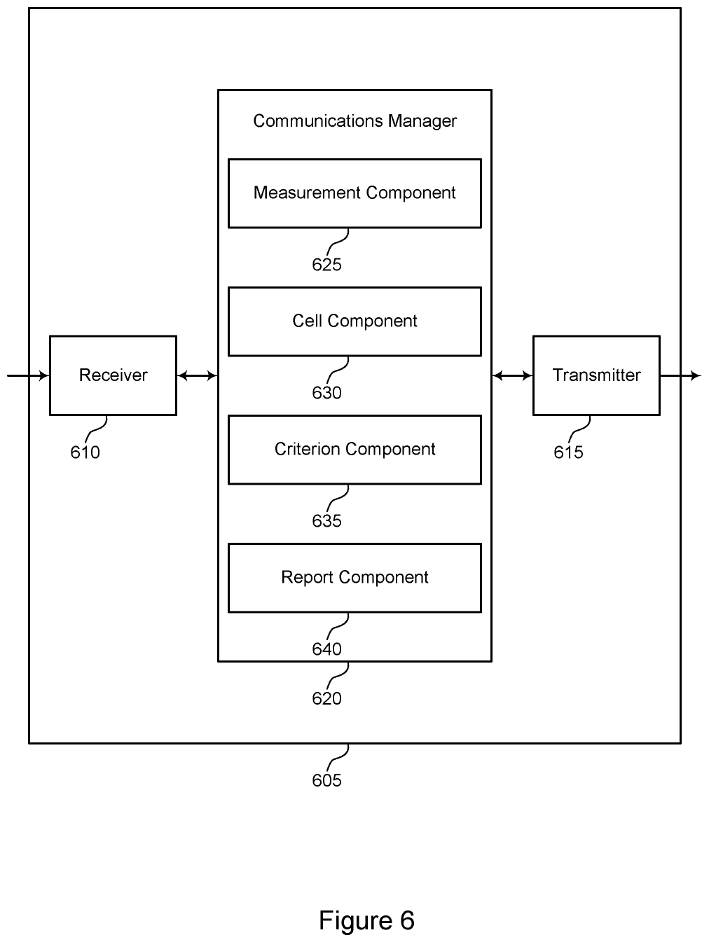

FIG. 6 shows a block diagram of a device 605 that supports a service continuity on a preferred cell during a connected mode mobility in accordance with aspects of the present disclosure. The device 605 may be an example of aspects of a device 505 or a UE 115. The device 605 may include a receiver 610, a transmitter 615, and a communications manager 620. The communications manager 620 can be implemented, at least in part, by one or both of a modem and a processor. Each of these components may be in communication with one another (for example, via one or more buses).

The receiver 610 may provide a means for receiving information such as packets, user data, control information, or any combination thereof associated with various information channels (for example, control channels, data channels, information channels related to service continuity on preferred cell during connected mode mobility). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (for example, control channels, data channels, information channels related to service continuity on preferred cell during connected mode mobility). In some examples, the transmitter 615 may be co-located with a receiver 610 in a transceiver component. The transmitter 615 may utilize a single antenna or a set of multiple antennas.

The device 605, or various components thereof, may be an example of means for performing various aspects of service continuity on preferred cell during connected mode mobility. For example, the communications manager 620 may include a measurement component 625, a cell component 630, a criterion component 635, a report component 640, or any combination thereof. In some examples, the communications manager 620, or various components thereof, may be configured to perform various operations (for example, receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations.

The communications manager 620 may support wireless communication at the device 605 (e.g., a UE) in accordance with examples as disclosed herein. The measurement component 625 may be configured as or otherwise support a means for performing a cell measurement for each of a set of cells while operating in a connected mode. The cell component 630 may be configured as or otherwise support a means for determining a subset of cells of the set of cells based at least in part on one or more of the cell measurement, cell-specific information, or UE-preferred cell information. The cell-specific information including one or more respective cell parameters associated with each cell of the subset of cells. The UE-preferred cell information including one or more respective preferred cell parameters. The criterion component 635 may be configured as or otherwise support a means for determining that one or more cells of the subset of cells satisfy one or more cell measurement report criteria. The report component 640 may be configured as or otherwise support a means for transmitting a cell measurement report including an indication of the one or more cells of the subset of cells based at least in part on the one or more cells of the subset of cells satisfying the one or more cell measurement report criteria.

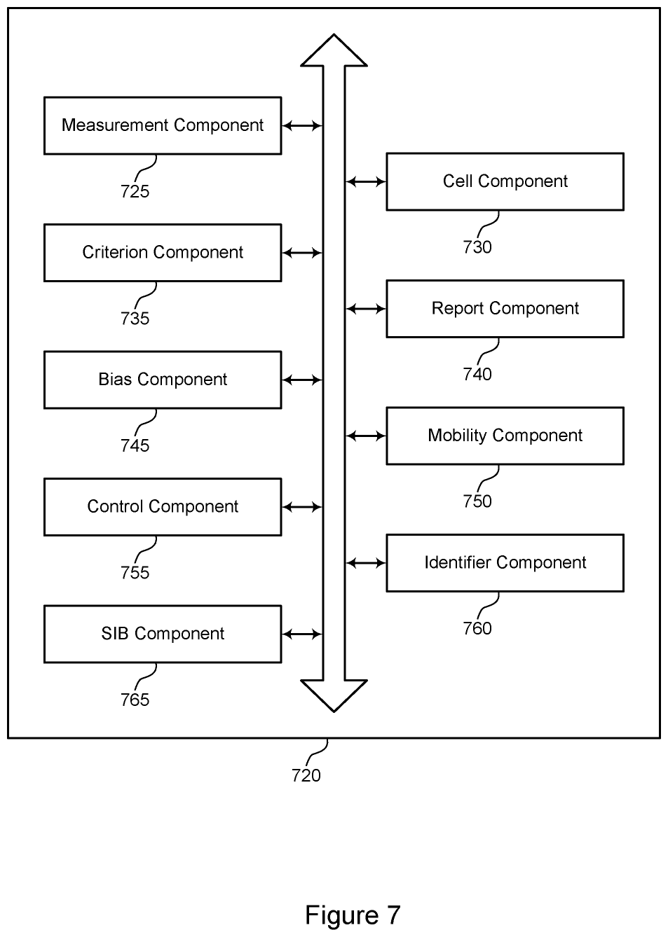

FIG. 7 shows a block diagram of a communications manager 720 that supports a service continuity on a preferred cell during a connected mode mobility in accordance with aspects of the present disclosure. The communications manager 720, or various components thereof, may be an example of means for performing various aspects of service continuity on preferred cell during connected mode mobility. For example, the communications manager 720 may include a measurement component 725, a cell component 730, a criterion component 735, a report component 740, a bias component 745, a mobility component 750, a control component 755, an identifier component 760, a SIB component 765, or any combination thereof. Each of these components may communicate, directly or indirectly, with one another (for example, via one or more buses).

The communications manager 720 may support wireless communication at a UE in accordance with examples as disclosed herein. The measurement component 725 may be configured as or otherwise support a means for performing a cell measurement for each of a set of cells while operating in a connected mode. The cell component 730 may be configured as or otherwise support a means for selecting a subset of cells of the set of cells based at least in part on one or more of the cell measurement, cell-specific information, or UE-preferred cell information. The cell-specific information including one or more respective cell parameters associated with each cell of the subset of cells. The UE-preferred cell information including one or more respective preferred cell parameters. The criterion component 735 may be configured as or otherwise support a means for determining that one or more cells of the subset of cells satisfy one or more cell measurement report criteria. The report component 740 may be configured as or otherwise support a means for transmitting a cell measurement report including an indication of the one or more cells of the subset of cells based at least in part on the one or more cells of the subset of cells satisfying the one or more cell measurement report criteria.

In some examples, the bias component 745 may be configured as or otherwise support a means for ordering, in the cell measurement report, the one or more cells of the subset of cells based at least in part on a respective priority associated with each cell of the one or more cells, the indication identifying the ordering of the one or more cells of the subset of cells in the cell measurement report. In some examples, the bias component 745 may be configured as or otherwise support a means for determining a respective priority for each of the one or more respective preferred cell parameters associated with the UE-preferred cell information. In some examples, the cell component 730 may be configured as or otherwise support a means for determining the subset of cells of the set of cells based at least in part on the determining of the respective priority for each of the one or more respective preferred cell parameters associated with the UE-preferred cell information. In some examples, the bias component 745 may be configured as or otherwise support a means for determining a preferred cell type from a set of multiple cell types based at least in part on the UE-preferred cell information. In some examples, the cell component 730 may be configured as or otherwise support a means for determining the subset of cells of the set of cells based at least in part on the preferred cell type and a respective cell type associated with each of the one or more cells of the subset of cells.

In some examples, the cell component 730 may be configured as or otherwise support a means for updating the UE-preferred cell information based at least in part on a battery power level (for example, an instantaneous battery power level) associated with the UE. In some examples, the cell component 730 may be configured as or otherwise support a means for determining the subset of cells of the set of cells based at least in part on the updated UE-preferred cell information. In some examples, the mobility component 750 may be configured as or otherwise support a means for determining a mobility state associated with the UE based at least in part on sensor information (for example, instantaneous sensor information) from one or more sensors associated with the UE. In some examples, the cell component 730 may be configured as or otherwise support a means for updating the UE-preferred cell information based at least in part on the mobility state associated with the UE. In some examples, the cell component 730 may be configured as or otherwise support a means for determining the subset of cells of the set of cells based at least in part on the updated UE-preferred cell information.

In some examples, the mobility component 750 may be configured as or otherwise support a means for updating the UE-preferred cell information based at least in part on a data throughput (for example, an instantaneous data throughput) associated with the UE. In some examples, the cell component 730 may be configured as or otherwise support a means for determining the subset of cells of the set of cells based at least in part on the updated UE-preferred cell information. In some examples, the mobility component 750 may be configured as or otherwise support a means for determining an enhanced coverage condition based at least in part on one or more of the cell measurement for each of the set of cells or sensor information from one or more sensors associated with the UE. In some examples, the cell component 730 may be configured as or otherwise support a means for updating the UE-preferred cell information based at least in part on the enhanced coverage condition. In some examples, the cell component 730 may be configured as or otherwise support a means for determining the subset of cells of the set of cells is based at least in part on the updated UE-preferred cell information.

In some examples, the control component 755 may be configured as or otherwise support a means for receiving control signaling indicating the UE-preferred cell information. In some examples, the cell component 730 may be configured as or otherwise support a means for determining the subset of cells of the set of cells based at least in part on the receiving of the control signaling indicating the UE-preferred cell information. In some examples, the UE-preferred cell information is based at least in part on one or more of a user preference associated with the UE, a network operator associated with the UE, or a subscription service associated with the UE. In some examples, the UE-preferred cell information corresponds to one or more of an HST network, a NR-DC, a CSG, a multimedia broadcast multicast service (MBMS), a C-V2X, a UE capability, or a configuration.

In some examples, the cell component 730 may be configured as or otherwise support a means for determining one or more RATs associated with the UE based at least in part on UE capability information. In some examples, the cell component 730 may be configured as or otherwise support a means for determining the subset of cells of the set of cells based at least in part on the determining of the one or more RATs associated with the UE. In some examples, the identifier component 760 may be configured as or otherwise support a means for determining one or more of a CGI, a network radio frequency spectrum band identifier, or a PCI based at least in part on the cell-specific information. In some examples, the cell component 730 may be configured as or otherwise support a means for determining the subset of cells of the set of cells based at least in part on the determining of one or more of the CGI, the network radio frequency spectrum band identifier, or the PCI.

In some examples, the cell component 730 may be configured as or otherwise support a means for determining the one or more respective cell parameters based at least in part on applying a bitmask to the cell-specific information. In some examples, the cell component 730 may be configured as or otherwise support a means for determining the subset of cells of the set of cells based at least in part on the determining of the one or more respective cell parameters. In some examples, the SIB component 765 may be configured as or otherwise support a means for receiving system information from each cell of the one or more cells of the subset of cells, the system information including a system information block (SIB). In some examples, the cell component 730 may be configured as or otherwise support a means for determining the one or more respective cell parameters based at least in part on the receiving of the system information from each cell of the one or more cells of the subset of cells. In some examples, the cell component 730 may be configured as or otherwise support a means for determining the subset of cells of the set of cells based at least in part on the receiving of the system information from each cell of the one or more cells of the subset of cells.

In some examples, the cell component 730 may be configured as or otherwise support a means for collecting the cell-specific information based at least in part on the cell measurement for each of the set of cells while operating in the connected mode. In some examples, the cell component 730 may be configured as or otherwise support a means for determining the subset of cells of the set of cells based at least in part on the collecting of the cell-specific information. In some examples, the control component 755 may be configured as or otherwise support a means for receiving control signaling indicating the cell-specific information. In some examples, the cell component 730 may be configured as or otherwise support a means for updating the cell-specific information based at least in part on the receiving of the control signaling. In some examples, the cell component 730 may be configured as or otherwise support a means for determining the subset of cells of the set of cells based at least in part on the updated cell-specific information. In some examples, the cell component 730 may be configured as or otherwise support a means for storing the cell-specific information in a local memory associated with the UE or a remote memory associated with the UE, the remote memory including a remote database. In some examples, the subset of cells is associated with one or more of an HST network, a NR-DC, a CSG, a MBMS, or a C-V2X.

In some examples, the measurement component 725 may be configured as or otherwise support a means for determining that the cell measurement for each of the set of cells corresponds to a RAT. In some examples, the cell component 730 may be configured as or otherwise support a means for selecting the UE-preferred cell information from a set of UE-preferred cell information based at least in part on the RAT associated with the cell measurement for each of the set of cells. In some examples, the cell component 730 may be configured as or otherwise support a means for determining the subset of cells of the set of cells based at least in part on the selecting of the UE-preferred cell information from the set of UE-preferred cell information.

In some examples, the criterion component 735 may be configured as or otherwise support a means for determining that the one or more cells of the subset of cells satisfy the one or more cell measurement report criteria based at least in part on the performing of the cell measurement for each of the set of cells while operating in the connected mode. In some examples, the cell component 730 may be configured as or otherwise support a means for determining the cell-specific information associated with each cell of the one or more cells of the subset of cells based at least in part on previously camping on each of the one or more cells of the subset of cells. In some examples, the cell component 730 may be configured as or otherwise support a means for determining the subset of cells of the set of cells based at least in part on the determining of the cell-specific information associated with each of the one or more cells of the subset of cells based at least in part on previously camping on each of the one or more cells of the subset of cells.

In some examples, the mobility component 750 may be configured as or otherwise support a means for performing a mobility procedure based at least in part on the transmitting of the cell measurement report including the indication of the one or more cells of the subset of cells, the mobility procedure including a cell handover procedure or a cell redirection procedure. In some examples, the mobility component 750 may be configured as or otherwise support a means for camping on a cell associated with the one or more cells of the subset of cells based at least in part on the performing of the mobility procedure. In some examples, the one or more cells of the subset of cells include one or more non-preferred cells based at least in part on one or more preferred cells of the subset of cells failing to satisfy the one or more cell measurement report criteria.

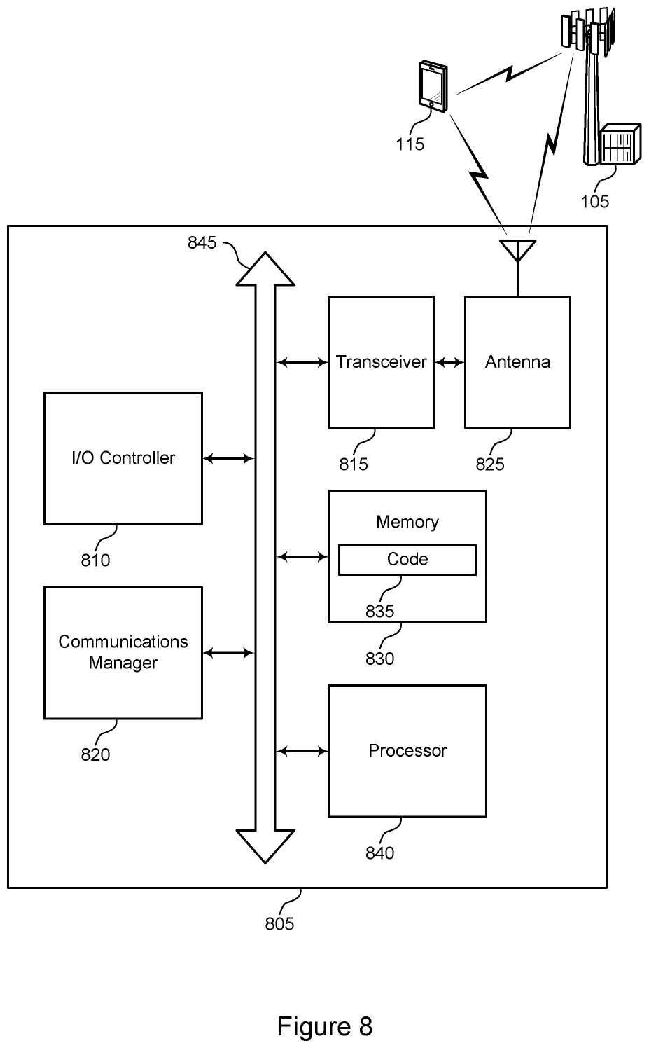

FIG. 8 shows a diagram of a system including a device 805 that supports a service continuity on a preferred cell during a connected mode mobility in accordance with aspects of the present disclosure. The device 805 may be an example of or include the components of a device 505, a device 605, or a UE 115. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (for example, operatively, communicatively, functionally, electronically, electrically) via one or more buses (for example, a bus 845).

The I/O controller 810 may manage input and output signals for the device 805. The I/O controller 810 may also manage peripherals not integrated into the device 805. In some examples, the I/O controller 810 may represent a physical connection or port to an external peripheral. In some examples, the I/O controller 810 may utilize an operating system such as iOS®, ANDROID®, MS-DOS®, MS-WINDOWS®, OS/2R, UNIX®, LINUX®, or another known operating system. Additionally or alternatively, the I/O controller 810 may represent or interact with a modem, a keyboard, a mouse, a touchscreen, or a similar device. In some examples, the I/O controller 810 may be implemented as part of a processor, such as the processor 840. In some examples, a user may interact with the device 805 via the I/O controller 810 or via hardware components controlled by the I/O controller 810.

In some examples, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some examples, the code 835 may not be directly executable by the processor 840 but may cause a computer (for example, when compiled and executed) to perform functions described herein. In some examples, the memory 830 may contain, among other things, a basic I/O system (BIOS), which may control basic hardware or software operation such as the interaction with peripheral components or devices.

The processor 840 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some examples, the processor 840 may be configured to operate a memory array using a memory controller. In some other cases, a memory controller may be integrated into the processor 840. The processor 840 may be configured to execute computer-readable instructions stored in a memory (for example, the memory 830) to cause the device 805 to perform various functions (for example, functions or tasks supporting service continuity on preferred cell during connected mode mobility). For example, the device 805 or a component of the device 805 may include a processor 840 and memory 830 coupled to the processor 840, the processor 840 and memory 830 configured to perform various functions described herein.

The communications manager 820 may support wireless communication at the device 805 (e.g., a UE) in accordance with examples as disclosed herein. For example, the communications manager 820 may be configured as or otherwise support a means for performing a cell measurement for each of a set of cells while operating in a connected mode. The communications manager 820 may be configured as or otherwise support a means for determining a subset of cells of the set of cells based at least in part on one or more of the cell measurement, cell-specific information, or UE-preferred cell information. The cell-specific information including one or more respective cell parameters associated with each cell of the subset of cells. The UE-preferred cell information including one or more respective preferred cell parameters. The communications manager 820 may be configured as or otherwise support a means for transmitting a cell measurement report including an indication of one or more cells of the subset of cells based at least in part on the one or more cells of the subset of cells satisfying one or more cell measurement report criteria. By including or configuring the communications manager 820, the device 805 may support techniques for improved communication reliability.

In some examples, the communications manager 820 may be configured to perform various operations (for example, receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of service continuity on preferred cell during connected mode mobility, or the processor 840 and the memory 830 may be otherwise configured to perform or support such operations.

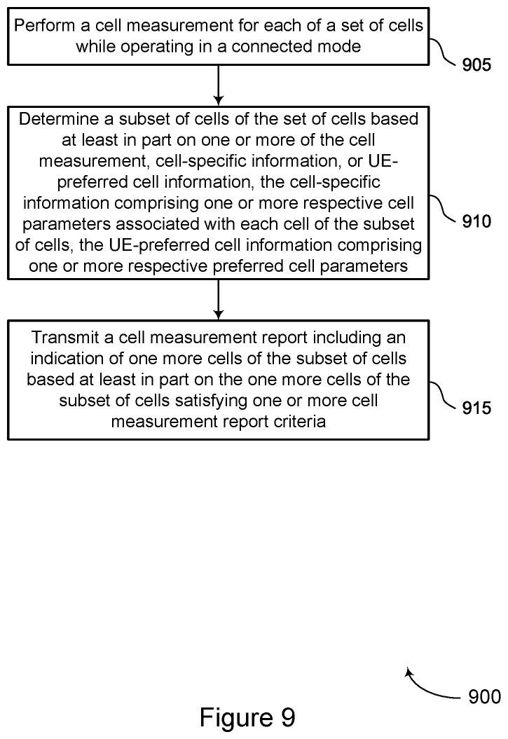

FIG. 9 shows a flowchart illustrating a method 900 that supports a service continuity on a preferred cell during a connected mode mobility in accordance with aspects of the present disclosure. The operations of the method 900 may be implemented by a UE or its components. For example, the operations of the method 900 may be performed by a UE 115 as described with reference to FIGS. 1-8. In some examples, a UE may execute a set of instructions to control the functional elements of the UE to perform the described functions. Additionally or alternatively, the UE may perform aspects of the described functions using special-purpose hardware.

At 905, the method may include performing a cell measurement for each of a set of cells while operating in a connected mode. The operations of 905 may be performed in accordance with examples as disclosed herein. In some examples, aspects of the operations of 905 may be performed by a measurement component 725 as described with reference to FIG. 7.

At 910, the method may include determining a subset of cells of the set of cells based at least in part on one or more of the cell measurement, cell-specific information, or UE-preferred cell information, the cell-specific information including one or more respective cell parameters associated with each cell of the subset of cells, the UE-preferred cell information including one or more respective preferred cell parameters. The operations of 910 may be performed in accordance with examples as disclosed herein. In some examples, aspects of the operations of 910 may be performed by a cell component 730 as described with reference to FIG. 7.

At 915, the method may include transmitting a cell measurement report including an indication of one or more cells of the subset of cells based at least in part on the one or more cells of the subset of cells satisfying one or more cell measurement report criteria. The operations of 915 may be performed in accordance with examples as disclosed herein. In some examples, aspects of the operations of 915 may be performed by a report component 740 as described with reference to FIG. 7.

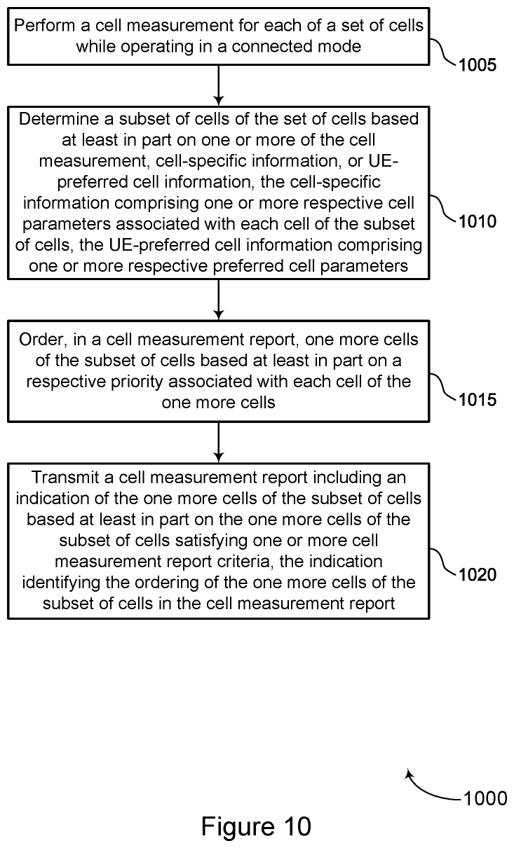

FIG. 10 shows a flowchart illustrating a method 1000 that supports a service continuity on a preferred cell during a connected mode mobility in accordance with aspects of the present disclosure. The operations of the method 1000 may be implemented by a UE or its components. For example, the operations of the method 1000 may be performed by a UE 115 as described with reference to FIGS. 1-8. In some examples, a UE may execute a set of instructions to control the functional elements of the UE to perform the described functions. Additionally or alternatively, the UE may perform aspects of the described functions using special-purpose hardware.

At 1005, the method may include performing a cell measurement for each of a set of cells while operating in a connected mode. The operations of 1005 may be performed in accordance with examples as disclosed herein. In some examples, aspects of the operations of 1005 may be performed by a measurement component 725 as described with reference to FIG. 7.

At 1010, the method may include determining a subset of cells of the set of cells based at least in part on one or more of the cell measurement, cell-specific information, or UE-preferred cell information, the cell-specific information including one or more respective cell parameters associated with each cell of the subset of cells, the UE-preferred cell information including one or more respective preferred cell parameters. The operations of 1010 may be performed in accordance with examples as disclosed herein. In some examples, aspects of the operations of 1010 may be performed by a cell component 730 as described with reference to FIG. 7.

At 1015, the method may include ordering, in a cell measurement report, one or more cells of the subset of cells based at least in part on a respective priority associated with each cell of the one or more cells. The operations of 1015 may be performed in accordance with examples as disclosed herein. In some examples, aspects of the operations of 1015 may be performed by a bias component 745 as described with reference to FIG. 7.

At 1020, the method may include transmitting the cell measurement report including an indication of the one or more cells based at least in part on the one or more cells of the subset of cells satisfying one or more cell measurement report criteria, the indication identifying the ordering of the one or more cells of the subset of cells in the cell measurement report. The operations of 1020 may be performed in accordance with examples as disclosed herein. In some examples, aspects of the operations of 1020 may be performed by a report component 740 as described with reference to FIG. 7.

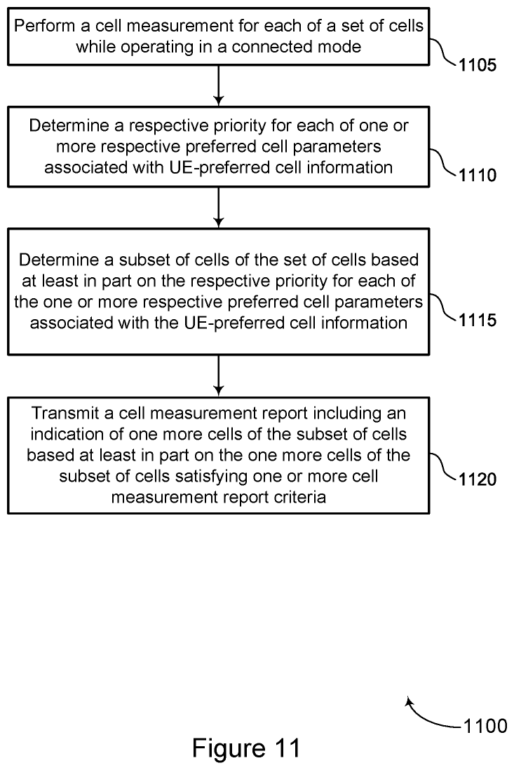

FIG. 11 shows a flowchart illustrating a method 1100 that supports a service continuity on a preferred cell during a connected mode mobility in accordance with aspects of the present disclosure. The operations of the method 1100 may be implemented by a UE or its components. For example, the operations of the method 1100 may be performed by a UE 115 as described with reference to FIGS. 1-8. In some examples, a UE may execute a set of instructions to control the functional elements of the UE to perform the described functions. Additionally or alternatively, the UE may perform aspects of the described functions using special-purpose hardware.

At 1105, the method may include performing a cell measurement for each of a set of cells while operating in a connected mode. The operations of 1105 may be performed in accordance with examples as disclosed herein. In some examples, aspects of the operations of 1105 may be performed by a measurement component 725 as described with reference to FIG. 7.

At 1110, the method may include determining a respective priority for each of one or more respective preferred cell parameters associated with UE-preferred cell information. The operations of 1110 may be performed in accordance with examples as disclosed herein. In some examples, aspects of the operations of 1110 may be performed by a bias component 745 as described with reference to FIG. 7.

At 1115, the method may include determining a subset of cells of the set of cells based at least in part on the respective priority for each of the one or more respective preferred cell parameters associated with the UE-preferred cell information. The operations of 1115 may be performed in accordance with examples as disclosed herein. In some examples, aspects of the operations of 1115 may be performed by a cell component 730 as described with reference to FIG. 7.

At 1120, the method may include transmitting a cell measurement report including an indication of one or more cells of the subset of cells based at least in part on the one or more cells of the subset of cells satisfying one or more cell measurement report criteria. The operations of 1120 may be performed in accordance with examples as disclosed herein. In some examples, aspects of the operations of 1120 may be performed by a report component 740 as described with reference to FIG. 7.

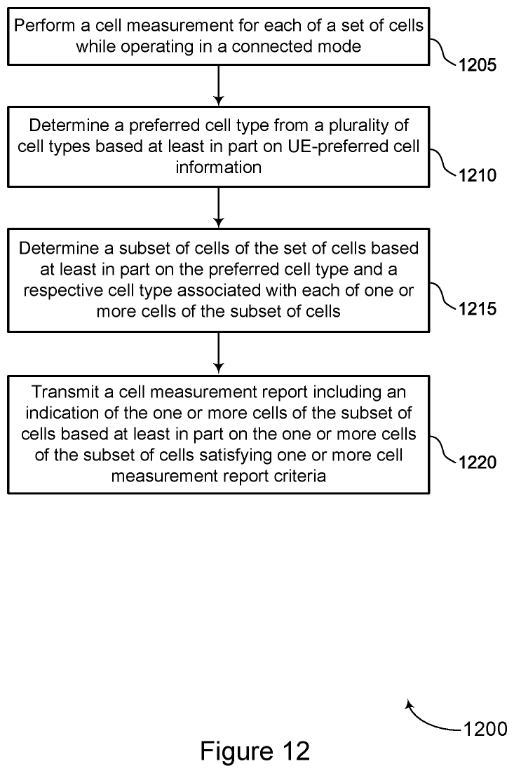

FIG. 12 shows a flowchart illustrating a method 1200 that supports a service continuity on a preferred cell during a connected mode mobility in accordance with aspects of the present disclosure. The operations of the method 1200 may be implemented by a UE or its components. For example, the operations of the method 1200 may be performed by a UE 115 as described with reference to FIGS. 1-8. In some examples, a UE may execute a set of instructions to control the functional elements of the UE to perform the described functions. Additionally or alternatively, the UE may perform aspects of the described functions using special-purpose hardware.

At 1205, the method may include performing a cell measurement for each of a set of cells while operating in a connected mode. The operations of 1205 may be performed in accordance with examples as disclosed herein. In some examples, aspects of the operations of 1205 may be performed by a measurement component 725 as described with reference to FIG. 7.

At 1210, the method may include determining a preferred cell type from a set of multiple cell types based at least in part on UE-preferred cell information. The operations of 1210 may be performed in accordance with examples as disclosed herein. In some examples, aspects of the operations of 1210 may be performed by a bias component 745 as described with reference to FIG. 7.

At 1215, the method may include determining a subset of cells of the set of cells based at least in part on the preferred cell type and a respective cell type associated with each cell of one or more cells of the subset of cells. The operations of 1215 may be performed in accordance with examples as disclosed herein. In some examples, aspects of the operations of 1215 may be performed by a cell component 730 as described with reference to FIG. 7.

At 1220, the method may include transmitting a cell measurement report including an indication of the one or more cells of the subset of cells based at least in part on the one or more cells of the subset of cells satisfying one or more cell measurement report criteria. The operations of 1220 may be performed in accordance with examples as disclosed herein. In some examples, aspects of the operations of 1220 may be performed by a report component 740 as described with reference to FIG. 7.

The following provides an overview of aspects of the present disclosure:
Aspect 1: A method for wireless communication at a UE, comprising: performing a cell measurement for each of a set of cells while operating in a connected mode: determining a subset of cells of the set of cells based at least in part on one or more of the cell measurement, cell-specific information, or UE-preferred cell information, the cell-specific information comprising one or more respective cell parameters associated with each cell of the subset of cells, the UE-preferred cell information comprising one or more respective preferred cell parameters: and transmitting a cell measurement report including an indication of one or more cells of the subset of cells based at least in part on the one or more cells of the subset of cells satisfying one or more cell measurement report criteria.
Aspect 2: The method of aspect 1, further comprising: ordering, in the cell measurement report, the one or more cells of the subset of cells based at least in part on a respective priority associated with each cell of the one or more cells, the indication identifying the ordering of the one or more cells of the subset of cells in the cell measurement report.
Aspect 3: The method of any of aspects 1 through 2, further comprising: determining a respective priority for each of the one or more respective preferred cell parameters associated with the UE-preferred cell information, wherein the determining of the subset of cells of the set of cells is based at least in part on the determining of the respective priority for each of the one or more respective preferred cell parameters associated with the UE-preferred cell information.
Aspect 4: The method of any of aspects 1 through 3, further comprising: determining a preferred cell type from a plurality of cell types based at least in part on the UE-preferred cell information, wherein the determining of the subset of cells of the set of cells is based at least in part on the preferred cell type and a respective cell type associated with each cell of the one or more cells of the subset of cells.
Aspect 5: The method of any of aspects 1 through 4, further comprising: updating the UE-preferred cell information based at least in part on a battery power level associated with the UE, wherein the determining of the subset of cells of the set of cells is based at least in part on the updated UE-preferred cell information.
Aspect 6: The method of any of aspects 1 through 5, further comprising: determining a mobility state associated with the UE based at least in part on sensor information from one or more sensors associated with the UE: and updating the UE-preferred cell information based at least in part on the mobility state associated with the UE, wherein the determining of the subset of cells of the set of cells is based at least in part on the updated UE-preferred cell information.
Aspect 7: The method of any of aspects 1 through 6, further comprising: updating the UE-preferred cell information based at least in part on a data throughput associated with the UE, wherein the determining of the subset of cells of the set of cells is based at least in part on the updated UE-preferred cell information.
Aspect 8: The method of any of aspects 1 through 7, further comprising: determining an enhanced coverage condition based at least in part on one or more of the cell measurement for each of the set of cells or sensor information from one or more sensors associated with the UE: updating the UE-preferred cell information based at least in part on the enhanced coverage condition, wherein the determining of the subset of cells of the set of cells is based at least in part on the updated UE-preferred cell information.
Aspect 9: The method of any of aspects 1 through 8, further comprising: receiving control signaling indicating the UE-preferred cell information, wherein the determining of the subset of cells of the set of cells is based at least in part on the receiving of the control signaling indicating the UE-preferred cell information.
Aspect 10: The method of any of aspects 1 through 9, wherein the UE-preferred cell information is based at least in part on one or more of a user preference associated with the UE, a network operator associated with the UE, or a subscription service associated with the UE.
Aspect 11: The method of any of aspects 1 through 10, wherein the UE-preferred cell information corresponds to one or more of an HST network, a NR-DC, a CSG, a MBMS, a C-V2X, a UE capability, or a configuration.
Aspect 12: The method of any of aspects 1 through 11, further comprising: determining one or more RATs associated with the UE based at least in part on UE capability information, wherein the determining of the subset of cells of the set of cells is based at least in part on the determining of the one or more RATs associated with the UE.
Aspect 13: The method of any of aspects 1 through 12, further comprising: determining one or more of a CGI, a network radio frequency spectrum band identifier, or a PCI based at least in part on the cell-specific information, wherein the determining of the subset of cells of the set of cells is based at least in part on the determining of one or more of the CGI, the network radio frequency spectrum band identifier, or the PCI.
Aspect 14: The method of any of aspects 1 through 13, further comprising: determining the one or more respective cell parameters based at least in part on applying a bitmask to the cell-specific information, wherein the determining of the subset of cells of the set of cells is based at least in part on the determining of the one or more respective cell parameters.
Aspect 15: The method of any of aspects 1 through 14, further comprising: receiving system information from each cell of the one or more cells of the subset of cells, the system information comprising a SIB: determining the one or more respective cell parameters based at least in part on the receiving of the system information from each cell of the one or more cells of the subset of cells, wherein the determining of the subset of cells of the set of cells is based at least in part on the receiving of the system information.
Aspect 16: The method of any of aspects 1 through 15, further comprising: collecting the cell-specific information based at least in part on the cell measurement for each of the set of cells while operating in the connected mode, wherein the determining of the subset of cells of the set of cells is based at least in part on the collecting of the cell-specific information.
Aspect 17: The method of any of aspects 1 through 16, further comprising: receiving control signaling indicating the cell-specific information: and updating the cell-specific information based at least in part on the receiving of the control signaling, wherein the determining of the subset of cells of the set of cells is based at least in part on the updated cell-specific information.
Aspect 18: The method of any of aspects 1 through 17, further comprising: storing the cell-specific information in a local memory associated with the UE or a remote memory associated with the UE, the remote memory comprising a remote database.
Aspect 19: The method of any of aspects 1 through 18, wherein the subset of cells are associated with one or more of an HST network, a NR-DC, a CSG, a MBMS, or a C-V2X.
Aspect 20: The method of any of aspects 1 through 19, further comprising: determining that the cell measurement for each of the set of cells corresponds to a RAT: and selecting the UE-preferred cell information from a set of UE-preferred cell information based at least in part on the RAT associated with the cell measurement for each of the set of cells, wherein the determining of the subset of cells of the set of cells is based at least in part on the selecting of the UE-preferred cell information from the set of UE-preferred cell information.
Aspect 21: The method of any of aspects 1 through 20, further comprising: determining that the one or more cells of the subset of cells satisfy the one or more cell measurement report criteria based at least in part on the performing of the cell measurement for each of the set of cells while operating in the connected mode.
Aspect 22: The method of any of aspects 1 through 21, further comprising: determining the cell-specific information associated with each cell of the one or more cells of the subset of cells based at least in part on previously camping on each cell of the one or more cells of the subset of cells, wherein the determining of the subset of cells of the set of cells is based at least in part on the determining of the cell-specific information associated with each cell of the one or more cells of the subset of cells.
Aspect 23: The method of any of aspects 1 through 22, further comprising: performing a mobility procedure based at least in part on the transmitting of the cell measurement report including the indication of the one or more cells of the subset of cells, the mobility procedure comprising a cell handover procedure or a cell redirection procedure: and camping on a cell associated with the one or more cells of the subset of cells based at least in part on the performing of the mobility procedure.
Aspect 24: The method of any of aspects 1 through 23, wherein the one or more cells of the subset of cells comprise one or more non-preferred cells based at least in part on one or more preferred cells of the subset of cells failing to satisfy the one or more cell measurement report criteria.
Aspect 25: An apparatus for wireless communication at a UE, comprising a processor: memory coupled with the processor; and instructions stored in the memory and executable by the processor to cause the apparatus to perform a method of any of aspects 1 through 24.
Aspect 26: An apparatus for wireless communication at a UE, comprising at least one means for performing a method of any of aspects 1 through 24.
Aspect 27: A non-transitory computer-readable medium storing code for wireless communication at a UE, the code comprising instructions executable by a processor to perform a method of any of aspects 1 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (in other words, A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
performing a cell measurement for each of a set of cells while operating in a connected mode;
determining a subset of cells of the set of cells based at least in part on one or more of the cell measurement, cell-specific information, or UE-preferred cell information, the cell-specific information comprising one or more respective cell parameters associated with each cell of the subset of cells, the UE-preferred cell information comprising one or more respective preferred cell parameters; and
transmitting a cell measurement report including an indication of one or more cells of the subset of cells based at least in part on each of the one or more cells of the subset of cells satisfying one or more cell measurement report criteria.

2. The method of claim 1, further comprising ordering, in the cell measurement report, the one or more cells of the subset of cells based at least in part on a respective priority associated with each cell of the one or more cells, the indication identifying the ordering of the one or more cells of the subset of cells in the cell measurement report.

3. The method of claim 1, further comprising determining a respective priority for each of the one or more respective preferred cell parameters associated with the UE-preferred cell information, wherein the determining of the subset of cells of the set of cells is based at least in part on the determining of the respective priority for each of the one or more respective preferred cell parameters associated with the UE-preferred cell information.

4. The method of claim 1, further comprising determining a preferred cell type from a plurality of cell types based at least in part on the UE-preferred cell information, wherein the determining of the subset of cells of the set of cells is based at least in part on the preferred cell type and a respective cell type associated with each of the one or more cells of the subset of cells.

5. The method of claim 1, further comprising updating the UE-preferred cell information based at least in part on a battery power level associated with the UE, wherein the determining of the subset of cells of the set of cells is based at least in part on the updated UE-preferred cell information.

6. The method of claim 1, further comprising:
determining a mobility state associated with the UE based at least in part on sensor information from one or more sensors associated with the UE; and
updating the UE-preferred cell information based at least in part on the mobility state associated with the UE, wherein the determining of the subset of cells of the set of cells is based at least in part on the updated UE-preferred cell information.

7. The method of claim 1, further comprising updating the UE-preferred cell information based at least in part on a data throughput associated with the UE, wherein the determining of the subset of cells of the set of cells is based at least in part on the updated UE-preferred cell information.

8. The method of claim 1, further comprising:
determining an enhanced coverage condition based at least in part on one or more of the cell measurement for each of the set of cells or sensor information from one or more sensors associated with the UE; and
updating the UE-preferred cell information based at least in part on the enhanced coverage condition, wherein the determining of the subset of cells of the set of cells is based at least in part on the updated UE-preferred cell information.

9. The method of claim 1, further comprising receiving control signaling indicating the UE-preferred cell information, wherein the determining of the subset of cells of the set of cells is based at least in part on the receiving of the control signaling indicating the UE-preferred cell information.

10. The method of claim 1, wherein the UE-preferred cell information is based at least in part on one or more of a user preference associated with the UE, a network operator associated with the UE, or a subscription service associated with the UE.

11. The method of claim 1, wherein the UE-preferred cell information corresponds to one or more of a high-speed train network, a new radio dual connectivity, a closed subscriber group k, a multimedia broadcast multicast service, a cellular vehicle-to-everything, a UE capability, or a configuration.

12. The method of claim 1, further comprising determining one or more radio access technologies associated with the UE based at least in part on UE capability information, wherein the determining of the subset of cells of the set of cells is based at least in part on the determining of the one or more radio access technologies associated with the UE.

13. The method of claim 1, further comprising determining one or more of a cell global identifier, a network radio frequency spectrum band identifier, or a primary cell identifier based at least in part on the cell-specific information, wherein the determining of the subset of cells of the set of cells is based at least in part on the determining of one or more of the cell global identifier, the network radio frequency spectrum band identifier, or the primary cell identifier.

14. The method of claim 1, further comprising determining the one or more respective cell parameters based at least in part on applying a bitmask to the cell-specific information, wherein the determining of the subset of cells of the set of cells is based at least in part on the determining of the one or more respective cell parameters.

15. The method of claim 1, further comprising:
receiving system information from each cell of the one or more cells of the subset of cells, the system information comprising a system information block; and
determining the one or more respective cell parameters based at least in part on the receiving of the system information from each cell of the one or more cells of the subset of cells, wherein determining the subset of cells of the set of cells is based at least in part on the receiving of the system information.

16. The method of claim 1, further comprising collecting the cell-specific information based at least in part on the cell measurement for each of the set of cells while operating in the connected mode, wherein the determining of the subset of cells of the set of cells is based at least in part on the collecting of the cell-specific information.

17. The method of claim 1, further comprising:
receiving control signaling indicating the cell-specific information; and
updating the cell-specific information based at least in part on the receiving of the control signaling, wherein the determining of the subset of cells of the set of cells is based at least in part on the updated cell-specific information.

18. The method of claim 1, further comprising storing the cell-specific information in a local memory associated with the UE or a remote memory associated with the UE, the remote memory comprising a remote database.

19. The method of claim 1, wherein the subset of cells are associated with one or more of a high-speed train network, a new radio dual connectivity, a closed subscriber group, a multimedia broadcast multicast service, or a cellular vehicle-to-everything.

20. The method of claim 1, further comprising:
determining that the cell measurement for each of the set of cells corresponds to a radio access technology; and
selecting the UE-preferred cell information from a set of UE-preferred cell information based at least in part on the radio access technology associated with the cell measurement for each of the set of cells, wherein the determining of the subset of cells of the set of cells is based at least in part on the selecting of the UE-preferred cell information from the set of UE-preferred cell information.

21. The method of claim 1, further comprising determining that the one or more cells of the subset of cells satisfy the one or more cell measurement report criteria based at least in part on the performing of the cell measurement for each of the set of cells while operating in the connected mode.

22. The method of claim 1, further comprising determining the cell-specific information associated with each of the one or more cells of the subset of cells based at least in part on previously camping on each of the one or more cells of the subset of cells, wherein the determining of the subset of cells of the set of cells is based at least in part on the determining of the cell-specific information associated with each of the one or more cells of the subset of cells.

23. The method of claim 1, further comprising:
performing a mobility procedure based at least in part on the transmitting of the cell measurement report including the indication of the one or more cells of the subset of cells, the mobility procedure comprising a cell handover procedure or a cell redirection procedure; and
camping on a cell associated with the one or more cells of the subset of cells based at least in part on the performing of the mobility procedure.

24. The method of claim 1, wherein the one or more cells of the subset of cells comprise one or more non-preferred cells based at least in part on one or more preferred cells of the subset of cells failing to satisfy the one or more cell measurement report criteria.

25. An apparatus for wireless communication at a user equipment (UE), comprising:
a processor;
memory coupled with the processor; and
instructions stored in the memory and executable by the processor to cause the apparatus to:
perform a cell measurement for each of a set of cells while operating in a connected mode;
determine a subset of cells of the set of cells based at least in part on one or more of the cell measurement, cell-specific information, or UE-preferred cell information, the cell-specific information comprising one or more respective cell parameters associated with each cell of the subset of cells, the UE-preferred cell information comprising one or more respective preferred cell parameters; and
transmit a cell measurement report including an indication of one or more cells of the subset of cells based at least in part on each of the one or more cells of the subset of cells satisfying one or more cell measurement report criteria.

26. The apparatus of claim 25, wherein the instructions are further executable by the processor to cause the apparatus to order, in the cell measurement report, the one or more cells of the subset of cells based at least in part on a respective priority associated with each cell of the one or more cells, the indication identifying the ordering of the one or more cells of the subset of cells in the cell measurement report.

27. The apparatus of claim 25, wherein the instructions are further executable by the processor to cause the apparatus to determine a respective priority for each of the one or more respective preferred cell parameters associated with the UE-preferred cell information, wherein the instructions to determine the subset of cells of the set of cells are further executable by the processor based at least in part on the determining of the respective priority for each of the one or more respective preferred cell parameters associated with the UE-preferred cell information.

28. The apparatus of claim 25, wherein the instructions are further executable by the processor to cause the apparatus to determine a preferred cell type from a plurality of cell types based at least in part on the UE-preferred cell information, wherein the instructions to determine the subset of cells of the set of cells are further executable by the processor based at least in part on comparing the preferred cell type and a respective cell type associated with each of the one or more cells of the subset of cells.

29. The apparatus of claim 25, wherein the instructions are further executable by the processor to cause the apparatus to update the UE-preferred cell information based at least in part on a battery power level associated with the UE, wherein the instructions to determine the subset of cells of the set of cells are further executable by the processor based at least in part on the updated UE-preferred cell information.

30. The apparatus of claim 25, wherein the instructions are further executable by the processor to cause the apparatus to determine a mobility state associated with the UE based at least in part on sensor information from one or more sensors associated with the UE; and
update the UE-preferred cell information based at least in part on the mobility state associated with the UE, wherein the instructions to select the subset of cells of the set of cells are further executable by the processor based at least in part on the updated UE-preferred cell information.
